(19) United States
(12) Patent Application Publication
(10) Pub. No.: US 2025/0200786 A1
(43) Pub. Date: Jun. 19, 2025

(54) SENSOR DATA ANALYSIS FOR GENERATION, PROCESSING, AND TRANSFER OF MOBILE OBJECT DATA

(71) Applicant: Invisible Holdings LLC, Sheridan, WY (US)

(72) Inventors: Raymond Francis St. Martin, Felton, CA (US); Andrew Lee Van Valer, Reno, NV (US)

(21) Appl. No.: 18/977,943

(22) Filed: Dec. 12, 2024

Related U.S. Application Data
(60) Provisional application No. 63/609,600, filed on Dec. 13, 2023.

(51) Int. Cl. G06T 7/70; G06T 7/20

(52) U.S. Cl. CPC G06T 7/70; G06T 7/20

(57) ABSTRACT

Sensor data is received from a plurality of sensors of the mobile object over time. Positioning data associated with a pose of the mobile object over time is received. A plurality of data points associated with the mobile object is generated. At least a first subset of the plurality of data points track changes within the sensor data over time. At least a second subset of the plurality of data points track changes to the pose of the mobile object over time. The plurality of data points is updated based on receipt of additional sensor data from the plurality of sensors. An arrangement of at least a third subset of the plurality of data points based on a request for information about the mobile object is outputted.

### CROSS-REFERENCE TO RELATED APPLICATIONS

The present application claims the priority benefit of U.S. Provisional Patent Application No. 63/609,600, filed on Dec. 13, 2023, entitled “METHOD OF AGGREGATION AND TRANSFER OF VEHICLE DATA,” the disclosures of which is all incorporated herein by reference in its entirety.

### FIELD OF THE DISCLOSURE

The present disclosure is generally related to generating an arrangement of data points over time for an object, and particularly to aggregating data for an object across a plurality of data sources and inputs and generating an arrangement of data points that represent a history of the object.

### BACKGROUND

Ensuring the accuracy and completeness of vehicle data improves the transfer of ownership process as it improves confidence in the value of the vehicle. Discrepancies or errors in vehicle records, such as incorrect or inaccurate descriptions, maintenance and/or accident history, missing documents, etc. can lead to disputes and legal complications in addition to poor buyer satisfaction. Effective data management systems and verification processes are essential to maintain reliable and up-to-date information about the vehicles being transferred.

Vehicle data is often collected and stored in various formats and systems by different parties, such as auto dealerships, financial institutions, insurance companies, and government agencies. Integrating and consolidating these diverse datasets can be challenging, especially when there are inconsistencies or incompatibilities between the systems. Standardization of data formats, establishing data sharing agreements, and utilizing technology solutions that facilitate seamless data integration can help overcome these hurdles.

Determining ownership and rights over vehicle data can be a complex issue. Multiple parties, including vehicle owners, auto salespersons, government entities, and third-party service providers, may have rights and interests in the data collected during the vehicle transfer process. Furthermore, some data may be sensitive or private in nature and should not be disclosed without permission from the individual to whom it pertains.

### SUMMARY

Examples of the present technology include a method, a system, and a non-transitory computer-readable storage medium for generating a searchable arrangement of data associated with a mobile object. Sensor data is received from a plurality of sensors of the mobile object over time. Positioning data associated with a pose of the mobile object over time is received. A plurality of data points associated with the mobile object is generated. At least a first subset of the plurality of data points track changes within the sensor data over time. At least a second subset of the plurality of data points track changes to the pose of the mobile object over time. The plurality of data points is updated based on receipt of additional sensor data from the plurality of sensors. An arrangement of at least a third subset of the plurality of data points based on a request for information about the mobile object is outputted.

In some examples, a method for generating a searchable arrangement of data associated with a mobile object includes receiving sensor data from a plurality of sensors of the mobile object over time. The method includes receiving positioning data associated with a pose of the mobile object over time. The method includes generating a plurality of data points associated with the mobile object. At least a first subset of the plurality of data points track changes within the sensor data over time. At least a second subset of the plurality of data points track changes to the pose of the mobile object over time. The method includes updating the plurality of data points based on receipt of additional sensor data from the plurality of sensors. The method includes outputting an arrangement of at least a third subset of the plurality of data points based on a request for information about the mobile object.

In some examples, a system for generating a searchable arrangement of data associated with a mobile object includes a memory and a processor. Execution of the instructions by the processor causes the processor to perform operations. The operations include receiving sensor data from a plurality of sensors of the mobile object over time. The operations include receiving positioning data associated with a pose of the mobile object over time. The operations include generating a plurality of data points associated with the mobile object. At least a first subset of the plurality of data points track changes within the sensor data over time. At least a second subset of the plurality of data points track changes to the pose of the mobile object over time. The operations include updating the plurality of data points based on receipt of additional sensor data from the plurality of sensors. The operations include outputting an arrangement of at least a third subset of the plurality of data points based on a request for information about the mobile object.

In some examples, a non-transitory computer-readable storage medium, having embodied thereon a program executable by a processor to perform a method for generating a searchable arrangement of data associated with a mobile object. The method includes receiving sensor data from a plurality of sensors of the mobile object over time. The method includes receiving positioning data associated with a pose of the mobile object over time. The method includes generating a plurality of data points associated with the mobile object. At least a first subset of the plurality of data points track changes within the sensor data over time. At least a second subset of the plurality of data points track changes to the pose of the mobile object over time. The method includes updating the plurality of data points based on receipt of additional sensor data from the plurality of sensors. The method includes outputting an arrangement of at least a third subset of the plurality of data points based on a request for information about the mobile object.

### BRIEF DESCRIPTION OF THE DRAWINGS

FIG. 1 is a block diagram illustrating an architecture of an object story generation system, according to some examples.

FIG. 2 illustrates an exemplary source database.

FIG. 3 illustrates an exemplary event database.

FIG. 4 illustrates an exemplary location database.

FIG. 5 illustrates an exemplary subject database.

FIG. 6 is a flowchart illustrating an exemplary function of a server system.

FIG. 7 is a flowchart illustrating an exemplary function of a data collection module.

FIG. 8 is a flowchart illustrating an exemplary function of a subject module.

FIG. 9 is a flowchart illustrating an exemplary function of an event module.

FIG. 10 is a flowchart illustrating an exemplary function of a location module.

FIG. 11 is a flowchart illustrating an exemplary function of a perspective module.

FIG. 12 is a flowchart illustrating an exemplary function of a transfer module.

FIG. 13 illustrates a process for generating a searchable arrangement of data associated with a mobile object in accordance with one embodiment.

FIG. 14 is a block diagram illustrating an example of a machine learning system.

### DETAILED DESCRIPTION

Many of the embodiments described herein are described in terms of sequences of actions to be performed by, for example, elements of a computing device. It should be recognized by those skilled in the art that specific circuits can perform the various sequence of actions described herein (e.g., application-specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present technology may be embodied in several different forms, all of which have been contemplated to be within the scope of the claimed subject matter. In addition, for each of the embodiments described herein, the corresponding form of any such embodiments may be described herein as, for example, a computer configured to perform the described action.

Physical objects comprise one of the most basic forms of human connection. Objects document human achievement, connecting people, places, history, emotions, memories, feelings, cultures, etc. Objects can inform us of who we are and how we fit into the world around us—past, present, and future.

All objects have origin stories and narratives, having either been made by someone, something, some event, somewhere, at some time—all have a story to tell.

Historically, printing revolutionized communication by replacing objects with text. Today, rapidly advancing and evolving technology will connect, merge, attach and link objects with personal narrative stories and context via the Internet and within the virtual world. In some embodiments, a virtual object, such as an SIO, may be directly connected with a physical object. Such as a vehicle. It's important to note that both the virtual object and physical object, while linked, may have separate values assigned to each of them. For example, a physical vehicle may have a monetary value that the virtual object does not convey. Conversely, the virtual object linked to the physical vehicle may have emotional or cultural value that is not contained within the physical vehicle per se, e.g., anecdotes, memories, photographs, or stories associated with the vehicle. Without objects, stories lack vitality. Without stories, objects lack meaning. When stories and objects are linked, they provide a richness that takes the “experiencer” on a journey from the commonplace to the remarkable.

These newly created “Objects+” will offer a universal language, not created for a specific audience, but they will “speak” to everyone. Objects associated and connected with relevant information will rapidly develop into the dominant method of articulating and communicating ideas, information, art, culture, music, sports, and literature, including various subject matter areas outlined in this document.

The Social Identity of Objects (SIO) and its technical framework of data and information free the fundamental limitation of physical objects alone and add context and human texture, liberating the isolation of the mere physicality of the object itself.

Liberated from a single isolated object, the SIO technology process will seamlessly associate all relevant information about a specific object and provide an increasingly valuable currency as a repository, sharing, and exchange platform.

Humans require intuitive and emotional references to connect objects, events, and cultures as they navigate today's technology-intensive environment. Available personal time and attention are becoming an increasingly valuable commodity. As escalating volumes of information compete for our attention, the more connected and contextual that information, the more effective the utilization of our time.

Interconnected, fast-moving, complex environments require more intuitive means of communication. The SIO technology platform is not simply a framework for more information but instead offers an interactive tool for better understanding.

The conventional conception of a physical object is that it exists in the physical world. Although alternative theories in quantum physics may present evidence to the contrary, physical objects or a physical body is a collection of matter existing within the boundary of a three-dimensional space. An object boundary may change over time, but it has a visible or tangible surface and specific properties.

For example, a ball is spherical. However, the sphere may have unique properties (i.e., a tennis ball is fuzzy, a marble is smooth, a golf ball has surface dimples, etc.). Therefore, the form of a sphere may have infinite properties attached to it. Therefore, an object has an identity that may change over time, with changes capable of being tracked and annotated in real-time. The initial object identity may change based on outside physical forces or input but can also be augmented and amplified by information associated with the object itself.

In some examples, the concepts of the presently disclosed technology can integrate and use associated information technologies and processes.

Today, an individual can interface with various devices that enable an enhanced understanding of the status and context of an object. For example, sensors can monitor systems and operating components of a house, and fitness trackers can help individuals understand more about their body's physical characteristics and performance. Objects can now combine technologies from multiple areas and integrate them into new infrastructures, providing a more robust and contextual experience for the user. As this process continues to grow and develop, we can reasonably expect every physical object will be identified with a unique internet address, allowing novel ways to experience and interact with physical objects and associated events connected to those objects. New information layers surrounding physical objects shape how users interact and connect the physical and virtual worlds.

With accelerating technological developments, it will become commonplace that people interact with objects on a new level in the virtual world via augmented reality (AR) and artificial intelligence (AI) capabilities. Information layers and narratives from various sources will be associated with specific objects, events, and products—enhancing value, engagement, and relationships with these objects, essentially creating a mixed reality environment with the convergence and synchronization of the real and virtual worlds. It's important to note that a plurality of value systems may be associated with an object, such as a vehicle. For example, a vehicle may have monetary value, social value, mechanical value, historical value, cultural value, environmental value, and many other value systems. SIO is implementing a personal approach to capturing, analyzing, and displaying data, realizing that subjectivity and context can play a defining role in understanding objects, events, social changes, and culture.

The Social Identity of Objects (SIO) comprises a novel method of discovering objects through a system of relationships, attributes, and context of specific objects. Searches can be made in various ways and can be associated with a single type or choice of the different types of searches outlined hereafter in this document. The searches can be made based on any attributes or relationships of the SIO's within a single database or group of public or private databases.

Search examples might include color, size, date, retailer, container size, and relationships to other SIOs connecting unlimited associations or attributes attached with each type of registered or non-registered user by a menu-driven by choices.

Individual users can deploy unique search criteria based on their specific requirements. For example, a consumer might wish to see the complete narrative history of an object or product in any possible views—limited, for instance, to publicly available information only. Conversely, an individual might wish to explore the history of an object (i.e., sporting memorabilia) through associated narratives and recollections via a network of private databases.

A manufacturer might wish to see the totality of details and attributes of all component materials, transportation, and pricing from the time of product inception. A pharmaceutical distributor might wish to have access to the entire product lifecycle, including its effects on the SIO such as feelings, returns, side effects, propensity to purchase again, etc.

In some examples, the concepts of the presently disclosed technology can integrate and use narrative history, product lifecycle, and associated technologies and processes.

It is safe to say that today's society, particularly the Internet, has experienced a proliferation of data unparalleled in human history. The terms “data” and “information” are often used interchangeably, but there are subtle differences between the two. Data is essentially “raw information” that can originate in any format as a number, symbol, character, word, code, text, visuals, sounds, graphics, etc. Data can also be analyzed and used to generate/create information that could not be obtained by simply observing the data element(s) alone. Information, therefore, is data put into context and utilized and understood in some significant way.

The term “Information” eludes a precise definition-although its properties and effects are ubiquitous and universal. The dictionary meaning of information includes the descriptors of ‘Knowledge,’ ‘Intelligence,’ ‘facts,’ ‘data,’ ‘a message,’ ‘a signal,’ which is transmitted by the act or process of communication. The information then can be roughly summarized as an assemblage of data in a comprehensible form, capable of communication.

Information only begins to embody meaning when presented in context for its receiver. When information is entered into and stored in an electronic database, it is generally referred to as data. After undergoing processing and retrieval techniques-such as associating attributes, brand, make, model, characteristics, qualities, traits, elements, descriptors, and other associated data formatting—output data can then be perceived as useable information and applied to enhance understanding of something or to do something.

The most common data types include 1.) Quantitative data is numerical data or data that can be expressed mathematically; 2). Qualitative data cannot be measured, counted, or easily expressed in numerical form. This data originates from text, audio, images, objects, artwork, etc. Qualitative data can be felt, described, and shared via data visualization tools, timeline graphics, infographics, and word narratives. 3). Nominal or categorical data is comprised of different categories that cannot be rank-ordered or measured. It is data that is simply used to identify or label a variable, including ethnicity, gender, eye color, country, marital status, favorite pet, type of bicycle, etc.; 4). Ordinal data contains values that follow a natural order within a known range. For example, income levels can be ranked in specific ranges in the order of priority or value but not used for calculating; 5). Discrete data, or categorical data, is divided into separate categories or clearly different groups. Discrete data contains a specific number of values that cannot be subdivided. For example, the number of people a company employs is a discrete data point; 6). Continuous data describes data that is measurable and observable in real-time. It can be measured on a scale or a continuum and further subdivided into finer values.

Data processing takes place within a framework or system, divided into three distinct stages: 1). Data is collected, gathered, and/or input from various sources—retail locations, manufacturers, distributors, museums, educational organizations, service centers, sensors, and individuals. 2). Data is sorted, organized, cleansed, and input into a digital repository, database, or system. 3). Transformed into a suitable format that users can understand and use.

Quality data is the primary requirement for transformation into quality information: 1). Data must come from a reliable source; 2). Data should be complete without missing details; 3). Systems must be in place to eliminate duplicated data; 4). Data must add relevance and value to the database to generate meaningful information; 5). Data must be current and timely.

In some examples, the concepts of the presently disclosed technology can integrate multiple data types, quality information, retrieval requirements, and associated technologies and processes.

Information is any data that can be collected, formatted, digitized, produced, distributed, understood, deployed, and transmitted to the user/viewer/receiver. While the concept of information is exceptionally broad, it can include anything from personal narratives, stories, conversations, art literature, visual images, and multi-media.

While information is virtually unlimited in scope and variety, there are common types or categories of information that are often cited: 1). Sensory information includes information that can be “experienced” by the human senses—sight, sound, smell, taste, and touch. These “sense information” variants are humans' primary connection to the physical/outside world; 2). Biological information includes any information found in the study of living organisms and/or associated processes that can control or be perceived by the body; 3). Conceptual information or any abstraction that can be experienced apart from physical reality. Concepts are the opposite of tangible items and have no physical manifestations; 4). Imagination information is constructed/conceived in the human mind in the form of an idea or story that can be communicated and used to create new thoughts and ideas; 5). Knowledge information includes “factual” information and “know-how” that is specifically designed and intended for human use and application; 6). Extended knowledge information can only be generated by human experience and action and not via an instruction manual or book; 7). Data or that which is specifically designed and utilized in systematic analysis, machine learning, and Artificial Intelligence. For example, a collection of test scores or temperature readings are examples of specific data elements; 8). Knowable unknowns and knowing what is unknown can be valuable information. The more knowledge we attain—the more we recognize is unknown; 9). Intelligence is the ability to build upon known information and create new meaning and connectivity with objects and emotions, cultures, and events; 10). Misinformation is information that is wrong or incorrect. Faulty data, flawed logic, and other errors can generate misinformation; 10). Disinformation is the deliberate distribution of “propaganda” designed to advocate for a specific message or agenda—often including a negative social context; 11). Situational information directly connected to a specific situation cannot be separated from its context; 12). Dispersed knowledge is information that exists in multiple locations/areas and not simply in one place. For example, multiple observers witnessing a single event from various viewpoints will form uniquely dispersed knowledge; 13). Asymmetric information includes information of “superior” value to comparable information. For instance, a stock trader may have critical information on a corporate earnings report to enable better transaction decisions.

In some examples, the concepts of the presently disclosed technology can integrate multiple information types, collected, formatted, digitized, distributed, and associated technologies and processes.

SIO utilizes eight specific data search view techniques in its system framework or what is called “Smart Label Views/Search” to access data and transform it into usable information. The first is the holistic view. A holistic view refers to the complete data set “picture.” Gaining this comprehensive view requires looking at the data throughout its entire lifecycle—from the moment an object originates until the information is needed by an individual at the current moment of retrieval.

The holistic data approach is designed to improve data analysis and integration by enabling information to be distributed across multiple platforms and systems efficiently and consistently. The first component of the holistic data process includes data collection—assembling information from a variety of sources, both public and private. Data collection can be compiled and identified from structured, semi-structured, and unstructured sources, including operational systems (i.e., CRM, financial systems), website information, social media, and user-supplied narratives and stories.

There are also various sources of vehicle data that is more social in nature, for example; a Facebook page for a particular vehicle, a car club website, or fan club of a particular manufacturer may include images of automobiles racing, performing daring maneuvers, or taken in interesting places or with interesting people. Some of the data may come from comments left by fans, owners, past owners, or perspective owners. From these sources, it is possible, through the social identity of objects to ascertain the vehicles online popularity, and some relationships in time, space and to other people, places, things or events.

The second component includes data integration and transformation, coalescing disparate data from multiple sources into an easily accessed and usable database(s). These integrated data and information assets provide the foundation for seamless and rapid access by end-users. Data integration and transformation rely on data quality, consistency, and control. The SIO solution provides processes that are repeatable, automated, and scalable to meet future user demand.

Third, presenting holistic data in a meaningful format(s) when requested, maintaining and supplementing data within a structural framework, increasing in value over time will remain a source of evolving relevance to users. Presentation techniques can uncover key metrics, trends, and exceptions and offer customized and unique visualizations.

Fourth, maintaining data quality and consistency is critical for the long-term viability of holistic data. SIO will deploy tactics including identifying data quality thresholds, fraud alerts, audit report functionality, and robust data governance protocols. All SIO master data repositories and data privacy strategies will be applied to all users.

In some examples, the concepts of the presently disclosed technology can integrate and use holistic data technologies and processes.

The humanistic view of data or human-centric approach is intended to provide personalized experiences for the user, offering a revolutionary future for data visualization. Unlike the traditional methodology where questions are asked, and answers are found, the humanistic view of data is contextual or related to a specific object, circumstance, event, or relationship. Data views are transformed into visual representations in this process, adding considerable substance and context to the experience.

SIO technology will leverage information from people with a personal connection to specific objects, events, and cultures. This human-centered approach to the origination, management, and interpretation of data provides value and importance for the people it came from and other people it will benefit from. SIO will create a trusted relationship strengthened by transparency within its system framework.

SIO is implementing a personal approach to how data is captured, analyzed, and displayed, realizing that subjectivity and context can play a defining role in understanding objects, events, social changes, and culture. A human-centric approach to data has the greatest potential for impact when going beyond gathering data to create personalized commercial/retail experiences. SIO will deploy its technology to understand the values and needs of people in the larger context of their lives.

In some examples, the concepts of the presently disclosed technology can integrate and use human-centric data technologies and processes.

Chronological, historical, or timeline view data, broadly considered, is collected about past events and circumstances about a particular object, information set, or subject matter. Historical data includes most data generated manually or automatically and tracks data that changes or is added over time. Historical data offers a vast array of use possibilities relating to objects, narratives, cultural events, project and product documentation, conceptual, procedural, empirical, and objective information, to name a few.

With increased cloud computing and storage capacities, data collection and retrieval allow for more data stored for greater periods with access by more users. Since data storage does require resources and maintenance, data life cycle management (DLM) can ensure that rarely referenced data can be archived and accessed only when needed.

Data preservation is essential and provides users 1.) the ability to understand the past; 2.) a deeper understanding of the evolution of patterns and information over time, providing insights and new perceptions about objects, events, and information. 3.) Enable possible future assessments about cultures, aesthetics, symbols, social interaction, and systems.

Historical data collections can originate from individuals using laptops, smartphones, tablets, or other connected devices. Data can be captured via smartphone cameras, collected via sensors, satellites and scanners, micro-chips, and massive arrays. There is no digital object or system that is not within the scope of digital preservation. Digital technologies are a defining feature of our age and have become the core commodity for industry, commerce and government, research, law, medicine, creative arts, and cultural heritage. The future will hinge on reliable access to digital materials while families and friends extend and sustain their relationships through digital interactions with objects and their history. The more society depends on the importance of digital materials and history, the greater the need for preservation and access by future generations and shared collaboration.

In some examples, the concepts of the presently disclosed technology can integrate and use chronological/historical data views and timelines and associated technologies and processes.

Data cluster view techniques are based on similarities among data points. Data clusters show which data points are closely related, so the data set can be structured, retrieved, analyzed, and understood more easily.

Data clusters are a subset of a larger dataset in which each data point is closer to the cluster center than to other cluster centers in the dataset. Cluster “closeness” is determined by a process called cluster analysis. Data clusters can be complex or simple based on the number of variables in the group.

Clustered data sets occur in abundance because all the events we experience and that we might wish to identify, understand, associate with specific objects and act upon have measurable durations. It, therefore, follows that the individual data points associated with each instance of such an event are clustered with respect to time. Many events associated with clustered data can be highly significant, and it is important to identify them as accurately as possible.

Clustering is deployed for high-performance computing. Since related data is stored together, the related data can be accessed more efficiently. Cluster views deliver two advantages: efficiency of information retrieval and reducing the amount of space required for digital storage. Information related and frequently requested is ideal for cluster viewed data requirements.

In some examples, the concepts of the presently disclosed technology can integrate clustered view data technologies and processes.

Data visualization is a methodology by which the data in raw format is portrayed to reveal a better understanding and provide a meaningful way of showcasing volumes of data and information. Various methods of data visualization and viewing options can be deployed for various purposes and information sets, including but not limited to: Biological views, Legacy views, sentimental views, significance views, monetary/financial views, consumer views, supply chain views, and social views, and other views not yet imagined. For example, in supply chain, there is a need to create data visualizations that capture the connectedness of objects through time and space in relation to variables such as materials, timelines, locations on a map, companies and humans involved in the construction, consumption and delivery of such objects. Additionally, the system may be able to display the “story” that is created and understood when these elements are combined. In one example, the system may display these objects as data as a user would see in a readout visualization, or data extraction interface. In another example, the system may display a view that shows the layers of connectedness and relationships of objects in a grid or other rich digital media display.

The system that asks the “right questions” will generate information that forms the foundations of choosing the “right types” of visualization required. Presenting information and narratives into context for the viewer provides a powerful technique that leads to a deeper understanding, meaning, and perspective of the information being presented.

A clear understanding of the audience will influence the visualization format types and create a tangible connection with the viewer. Every data visualization format and narrative may be different, which means data visualization types will be fluid and ultimately change based on goals, aims, objects, or topics. Presentation technologies are becoming increasingly dynamic, and by better understanding user-based preferences, individual stories can be accurately portrayed.

In some examples, the concepts of the presently disclosed technology can integrate multiple data visual format technologies and processes.

A hierarchical data view is defined as a set of data items related to each other by categorized relationships and linked to each other in parent-child relationships in an overall “family tree” structure. When information needs to be retrieved, the whole tree is scanned from the root node down. Modern databases have evolved to include the usage of multiple hierarchies over the same data for faster, easier searching and retrieval.

The hierarchical structure of data is important as the process of data input, processing, retrieval, and maintenance is an essential consideration. An example would include a catalog of products, each within specific categories. Categories could be high-level categories such as clothing, toys, appliances, and sporting goods—however, there may also contain subcategories within those: in clothing, there may be pants, jackets, shoes—toys might include board games, action figures, and dolls. Within subcategories, there may be even more categories and so on.

The hierarchical database model offers several advantages, including but not limited to 1). The ability to easily add and delete new information; 2). Data at the top of the hierarchy can be accessed quickly via explicit table structures; 3). Efficient for linear data storage applications; 4). It supports systems that work through a one-to-many relationship; 5). It's a proven storage and retrieval model for large data sets; 6). Promotes data sharing; 7). A clear chain of authority and security.

In some examples, the concepts of the presently disclosed technology can integrate hierarchical database models, technologies, and processes.

A spherical data view is a form of non-linear data in which observational data are modeled by a non-linear combination model relying on one or more independent variables. Non-linear methods typically involve applying some type of transformation to the input dataset. After the transformation, many techniques can then try to use a linear method for classification.

Data credibility is a major focus implemented to ensure that databases function properly and return quality data and accurate information to the user. In the SIO system, a weighted average technique of ensuring data quality can be utilized and includes processing a collection of each of the data attributes such as location, type of device, history, individual, current, and past relationships with other SIOs and many others to determine the credibility of the SIO data. For example, a search for a product grown in a certain location by a specific farm might include information relating to climate, seed varietal, farm name, sustainable price, location, compliance with regulations, and organic certification. This process evaluates the average of a data set, recognizing (i.e., weighing) certain information as more important than others.

Verifying data integrity is an extremely important measure since it establishes a level of trust a user can assign to the information returned and presented. Credible data can only be assured when robust data management and governance are incorporated into the system. Satisfying the requirements of intended users and associated applications will assure the highest quality data, including but not limited to 1). Accuracy from data input through data presentation; 2). Exceptional database design and definition to avoid duplicate data and source verification; 3). Data governance and control; 4). Accurate data modeling and auditing; 5). Enforcement of data integrity; 6). Integration of data lineage and traceability; 7). Quality assurance and control.

In some examples, the concepts of the presently disclosed technology can integrate spherical data views and data credibility control technologies and processes.

A framework in computer programming is a structure used as a base environment or foundation upon which programmers and developers create software applications deployed on a specific platform(s). Frameworks are designed to be versatile, robust, and efficient, offering a collection of software tools and services that eliminate low-level and repetitive processes, allowing developers to focus on the high-level functionality of the application itself. Programming frameworks are typically associated with a specific programming language and are designed to accelerate the development process, so new applications can be created and deployed quickly.

A blockchain framework provides a unique data structure in the context of computer programming, consisting of a network of databases/virtual servers connected via many distinct user devices. Whenever a contributor in a blockchain adds data (i.e., a transaction, record, text, etc.), it creates a new “block,” which is stored sequentially, thereby creating the “chain.” Blockchain technology enables each device to verify every modification of the blockchain, becoming part of the database and creating an exceptionally strong verification process.

Security provided by this distributed ledger/data process is among the most powerful features of blockchain technology. Since each device holds a copy of these ledgers, the system is extremely difficult to hack-if an altered block is submitted on the chain, the hash or the keys along the chain are changed. The blockchain provides a secure environment for sharing data and is increasingly used in many industries, including finance, healthcare, and government.

Blockchains are typically divided into three distinct types and can be managed differently by the network participants. They include 1). Public blockchain: open to a wide range of users where anyone can join a network and are by design “decentralized systems” where participants can read, add entries, and participate in processes. Public blockchains are not controlled by third parties; 2). Private blockchain: open to a limited number of people, is typically used in a business environment where the content in the blockchain is not shared with the public and can be controlled by a third party; 3). Hybrid blockchain: a mixture of private and public blockchains that is not open to everyone but still offers data integrity, transparency, and security features that are novel components of the technology. Blockchain technology is a novel and disruptive technology and can accommodate highly scalable applications.

In some examples, the concepts of the presently disclosed technology can integrate computer programming and blockchain technologies and processes.

Blockchain security and cryptographic protocols make this technology increasingly attractive for business models and applications where provenance and authenticity are critical. While blockchain is well-known for applications in the cryptocurrency world, it is becoming an essential component of applications for non-fungible tokens (NFT).

If something is fungible—it is interchangeable with an identical item—NFTs, on the other hand, are unique and non-interchangeable units of data stored on a blockchain—therefore, one NFT is not equal to another. NFTs are usually associated with reproducible digital files such as photos, artwork, historical objects, narratives, videos, and audio. The possibilities for NFTs within the blockchain framework are virtually endless because each NFT is unique yet can evolve over time. The value of NFTs is in their “uniqueness” and ability to represent physical objects in the digital world.

Once an NFT is created, it is assigned a unique identifier that assures authenticity and originality. Each NFT is unique, so all the information about the token is stored on the blockchain—meaning if one “block” in the chain fails, information will still exist on another block, ensuring the NFT remains safe and secure indefinitely.

The unique capabilities of blockchain technology coupled with NFTs guarantee the authenticity, originality, and longevity of objects, artwork, cultural items, and music tracks, among a host of other categories. With blockchain technology, it is impossible to copy or reproduce an NFT, and ownership is recorded in an unalterable way.

Tracking and exchanging real-world assets in the blockchain can assure that the asset has not been duplicated or fraudulently altered. NFTs are not limited to purely digital items, but digital versions of objects from the physical world can be attached to specific narratives and stories. Unlike digital media, represented by codes and numbers—physical objects are separate entities that can carry intuitive connections.

For instance, human memories can be connected to a physical object providing meaning and context for the viewer. A toy may be linked with a story that can transport the viewer back to a childhood experience—not necessarily connected to any monetary value but a narrative memory wrapped within the object itself. Narratives can be associated with anything, from a book of recipes passed from one generation to the next or table favors from a wedding. We are a society that collects “things,”—and these objects all have unique meaning and context.

An innovative example of this technology is occurring in cultural heritage preservation. Collecting and preserving cultural heritage data, objects, and associated narratives allow communities to interact with historical and culturally relevant artifacts and objects in unique and novel ways. These objects communicate with the viewer through the memories we associate with them. Global historical events and objects are inextricably linked to personal histories.

The lines of separation between the digital and physical worlds are converging-as virtually any object can be connected to the Internet. Enhanced programming platforms, sensors, AI, Augmented reality, intuitive applications, and increased bandwidth capabilities will make “connected objects” more useful and interactive. As information proliferates, the power to connect stories with objects will shape wisdom, culture, and future generations.

In some examples, the concepts of the presently disclosed technology can integrate Non-fungible tokens (NFT) technologies and processes.

“Historocity” or “Historacity,” as defined by the inventors herein, is a specialized metric designed to quantify the aggregated historical value of an artifact, or a collection thereof. Unlike the traditional concept of historicity, which is limited to the verification and authentication of historical events, characters, or phenomena, Historocity expands the scope to include three additional dimensions: popularity, trust or certification, and value associated with objects. Popularity is measured by the level of public attention an artifact or its associated elements have garnered over time, through public mentions, scholarly references, or social interactions. Trust or certification quantifies the level of confidence in the provenance or authenticity of the artifact, established through expert opinions, credentials, or documented evidence. The value associated with objects allows for comparison of other similar objects across many domains, monetary value being the most obvious. For example, two nearly identical baseballs may sell for entirely different orders of magnitude based on the stories told about them, e.g., a slightly used baseball may sell at a yard sale for $2 after a member of the household has lost interest in the sport, compared to Mark McGwire's No. 70 in 1998 baseball, which sold for $3 million. The calculation of Historocity integrates these multidimensional data points to produce a composite value that can be represented numerically or categorically. In some instances, this value is further refined by integrating social or sentimental factors, yielding an even more comprehensive value termed “Aggregated Historocity.” This aggregated value not only serves as a holistic measure of the artifact's historical significance but also holds transactional utility. It can be sold, transferred, willed, or loaned either independently of the physical artifact or in conjunction with it. Historocity provides a robust framework for evaluating the comprehensive historical significance of artifacts and collections, offering utility for curators, researchers, and collectors alike.

The Social Identity of Objects and their associated Historocity scoring system presents a novel method of determining an object's significance based on a combination of various value systems. Throughout history and across cultures, value systems have continuously evolved to shape human beliefs, behaviors, and decision-making processes. For instance, the perception of time has been universally regarded as a treasured resource, prompting individuals to focus on punctuality and efficiency. Similarly, the value attached to money, and its cultural derivatives like currency, signifies the emphasis on financial stability and prosperity. While these tangible assets possess clear worth, abstract concepts like social and relationship values underscore the importance of interpersonal connections, community bonds, and societal contributions. Historical values emphasize the reverence for past lessons, traditions, and inheritances, whereas personal and intrapersonal values reflect an individual's internal beliefs about self-worth, growth, and potential. Objects can also carry sentimental value, representing emotional bonds, memories, or significant life moments. Spiritual systems provide perspectives on existential beliefs and moral codes, influencing one's view on life's purpose and ethical considerations. Furthermore, in an era of growing environmental consciousness, the significance of preserving our natural surroundings is reflected in environmental values. Lastly, educational value, focusing on the efficacy and relevance of learning experiences, emphasizes the importance of knowledge acquisition and cognitive development. By integrating these multifaceted value systems into the Historocity scoring, the Social Identity of Objects offers a comprehensive, nuanced, and culturally sensitive method to ascertain an object's importance in a given context.

To further expand on the Historocity scoring system in the Social Identity of Objects, other value systems may be considered. Incorporation of emotional value addresses the complex spectrum of human feelings attached to objects or experiences. This encompasses not only positive sentiments like joy and nostalgia but also accounts for potential negative associations. Understanding that our connections with items aren't merely functional but deeply emotional provides a holistic view of an object's significance. Location value accentuates the importance of geographical positioning in determining an object's relevance. Economic and social attributes of a location, combined with factors like access to essential amenities and safety, play a pivotal role in an object's value. This dimension not only provides context but also highlights the dynamic interplay of market forces and socio-economic conditions in shaping perceptions of value. Intrinsic value incorporates a philosophical perspective of the value of an object, emphasizing the inherent worth of an object or entity, irrespective of its market-driven or functional value, this may be especially true when considering human life or other fundamental human values. This provides the concept that certain objects, beings, or environments possess value purely based on their existence or innate qualities outside of any other value system. Spatial value can be considered in terms of, for example, urban planning and architecture, stressing the value derived from specific spatial contexts, e.g., a certain amount of square or cubic footage my have some value regardless of (or despite) its contents. This could be an urban park or a historical site. The worth isn't just aesthetic but also pertains to economic implications, functionality, and broader urban development strategies. Physical value may be tangible metrics on the material properties and performance capabilities of objects.

The Historocity scoring system of the Social Identity of Object may further incorporate or reflect upon various additional value paradigms, including Fiat value, underpinned by government regulation and policy, remains contingent upon macroeconomic trends, political stability, and regulatory decisions, rendering its value both influential and volatile. Conversely, the cryptocurrency value, powered by cryptographic technology such as blockchain, is anchored in decentralized systems and garners its worth from technological trust and its potential to redefine financial structures. Driven by market sentiments, technological evolutions, and regulatory climates, its fluidity mirrors the dynamic nature of digital asset valuation. The intellectual value of a thought or idea can be both palpable, evidenced by breakthroughs and inventions, and intangible, manifesting as sources of intellectual or aesthetic stimulations. These thoughts, influenced by sociocultural dynamics, remain transformative to societies. Adjacently, copyright value provides protection to the value created by creativity and innovation, offering both economic rights and a moral stance to creators. Through licensing and intellectual property management, this value protects and incentivizes originality. The essence of moral value is rooted in the ethical compass guiding societies and individuals. Often universal, and sometimes relativistic based on cultural differences, these principles provide the ethical framework navigating society and life. Similarly, cultural value celebrates the plethora of human expressions, traditions, and practices, emphasizing shared heritages and identities. Regional value underscores the significance of geographical locales, intertwining economic, cultural, and social dimensions. This value promotes local entrepreneurship, strengthens cultural and social assets, and galvanizes community pride. Through regional development endeavors, it perpetually seeks to uplift, innovate, and harness regional potential.

Furthermore, a Historocity scoring system endeavors to incorporate a myriad of value systems, such as, for example human value, which emphasizes the innate worth of every individual, highlighting the significance of human rights, social justice, and overall well-being. Such a system promotes respect, autonomy, and the holistic growth of each individual, free from discrimination. Sustainability value underscores the importance of sustainable practices that balance economic, social, and environmental considerations. The objective of such a value system is to optimize present needs without jeopardizing future generations, emphasizing the reduction of environmental footprints and promoting sustainable development. Business value offers a perspective on the significance of a company's contributions to stakeholders, quantified through financial metrics, market presence, and societal impact. Economic value provides a means to evaluate the worth of goods, services, or assets in a market setting. It not only addresses the demand-supply dynamics and innovation but may also underscore the importance of addressing societal issues and environmental protection. Self-value emphasizes the inherent worth and self-perception an individual possesses, reflecting on their mental well-being and overall life satisfaction. It is intrinsically linked to one's self-image, confidence, and overall life outcomes. Environmental value emphasizes the significance of preserving and valuing the natural environment. Instrumental value provides an estimate of the tangible benefits derived from the environment, signifying the interconnectedness between human well-being and environmental health. Health value focuses on the importance of physical and mental health, which is fundamental for individual well-being and societal progress.

In the Social Identity of Objects (SIO) network, a Historocity scoring system is introduced to facilitate the exploration and ranking of individual objects and collections. The system computes relative scoring metrics based on multiple value systems, both mentioned and unmentioned. Users can evaluate and order objects or collections in accordance with these metrics, providing flexibility to accommodate any past, present, or future value system for comprehensive object assessment.

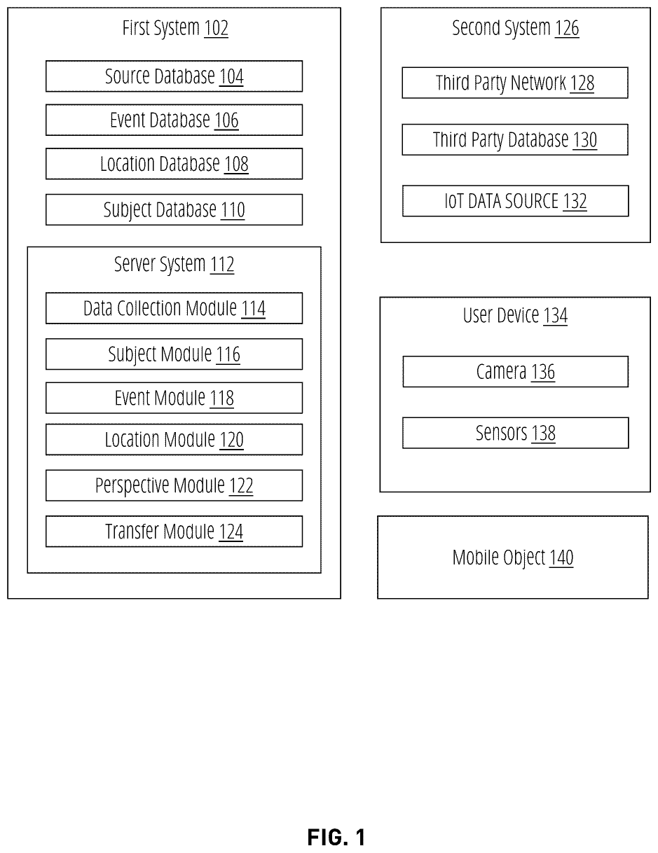

FIG. 1 is a block diagram illustrating an architecture of an object story generation system. The object story generation system is a system that can organize and manage data and information and associate the data and information with a story associated with a mobile object. A mobile object can be, for example, a vehicle, such as a car, truck, plane, boat, etc. In some examples, the mobile object can be a natural object that can move or be moved, such as a rock, a planet, an animal, etc. The data and information can be stored as objects with rich data attributes such as materials used during construction, people associated with the mobile object, events, etc. These objects can be created and edited by users or automatically by modules. The system also includes references to source materials or source files stored in a source database, which may be, for example, such as individuals providing narratives, recordings, written descriptions, pictorial representations, property documents, news articles, social media posts, digital or physical archives, or academic papers, etc. These sources are used to create and support the building blocks, allowing users to reference the original source file and information originated and how it is continuously related to other objects.

This system comprises of a first system 102 that may collect and store a social identity of objects (SIO's). The first system 102 enables instantiation of SIO data for each object in the system, and recommends data based on time, place, space, written tags, photos, videos, descriptions, commonality, and emotions to be displayed through an interface, among other functions. The first system 102 may further be used to assess and verify the accuracy of an object or stories which may be comprised of one or more objects. Truth may be based upon verifiable facts, or by corroborating one or more objects with one or more similar or verifiable accounts. For example, a plurality of accounts may describe the series of events during a baseball game. While the perspectives of each account may vary, some common elements can be corroborated such as the teams and players involved, the location and time of the game, the weather during the game, the plays which occurred, etc. Verifying common details may provide confidence that the source of the data is trustworthy and therefore their account can be trusted. By contrast, if elements of an individual's account conflicts with the majority of other accounts, then the individual may be deemed less trustworthy, and therefore their story may not be trusted. A first system 102 may additionally aggregate data, such as data about human history, and upon selection of one or more parameters, may generate a story comprised of one or more relevant accounts of subjects, events, and/or locations which may then be structured, such as in the chronological order of events, or as locations and/or features as a map, before being presented to a user.

A source database 104 stores data relating to sources of data and the trustworthiness or reliability of the source. A source may refer to an individual providing one or more stories, such as via oral dictation, uploading a recording, providing a written dictation, a pictorial representation, etc., or may alternatively refer to a written text, publication, publisher, website, company, or other organization, etc.

A source may additionally refer to third party networks 128, third party databases 130, IoT data sources 132, etc. In some embodiments, a source may refer to a user device 134 or a camera 136 or a sensor 138. In an embodiment, a source may be a website such as Wikipedia. In another embodiment, a source may be a news company, website, or newspaper publisher such as Reuters or the Associated Press. In another embodiment, a source may be a particular weather station or meteorologist. The trustworthiness or reliability may be represented by a binary ‘trustworthy’ or ‘untrustworthy’ data type or may alternatively be represented by a qualitative range of values such as ‘trustworthy’, ‘somewhat trustworthy’, ‘unknown trustworthiness’, ‘somewhat untrustworthy’, or ‘untrustworthy’. Similarly, trustworthiness or reliability may be represented by a quantitative value, such as a score. The score may represent a probability that the source can be trusted, which may be interpreted as the likelihood that the source is accurately describing the truth. A quantitative value may alternatively utilize a regressive method to adjust the source's reliability score based upon each accurate or inaccurate contribution which may comprise any of a story, object, object characteristic, etc. Source reliability may additionally be impacted by credentials, such as whether a source is determined to be a specialist in a given field, or alternatively if manually adjusted. Additionally, the amount a reliability score is adjusted may be impacted by the degree to which the source's contribution is inaccurate or the relative reliability scores of corroborating sources and data. Sources may further comprise records such as invoices, permits, contracts, etc.

An event database 106 stores data related to time-related events or data comprising time-based data such as one or more dates, times, and may additionally include descriptions and/or characteristics of what occurred at the specific date and/or time. The resolution of event data in respect to time may vary. For example, an event may reference a time accurate to a second or a fraction of a second, or may reference a specific minute, hour, day, week, month, year, or span of multiple years. For example, an event may describe the purchase of a particular mobile object 140, such as a Ford F-150. An event may also comprise construction or manufacturing events, such as manufacture and/or maintenance of a mobile object 140. Events may further include occurrences at a particular location which may be relevant to the mobile object 140 such that the mobile object 140 was present. In an embodiment, an event is the manufacture of a 2013 model year Ford F-150. In an additional embodiment, an event is the purchase of a 2013 Ford F-150. In some embodiments, the event may additionally comprise a duration. For example, a mobile object 140 may be involved in an accident during which it received damage on Nov. 21, 2013, and the repairs may take until Feb. 4, 2014 to be fully completed. In some embodiments, the event may comprise a start date and/or time, an end date and/or time, or both a start and end date and/or time. In another embodiment, an event is a maintenance event such as an oil change, or alternatively a brake replacement. Event data from one source may be associated with data from a plurality of other sources. Associated data may not match exactly. For example, if a first source was a mechanic who completed repairs to a 2013 Ford F-150 on Feb. 1, 2014, however the mobile object 140 is not completely repaired until Feb. 4, 2014 after having the wheels aligned and an inspection performed. The same would be true if they used different resolutions of time-based data, such as if the mobile object 140 was manufactured in 2012, or more specifically on Sep. 12, 2012. Events may further refer to a subject's personal experience such as their first time driving a particular mobile object 140, receiving a speeding ticket, etc.

A location database 108 stores data related to location related data which may be relevant to a mobile object 140. The location data may comprise an address. Alternatively, or in addition to an address, the location may be comprised of one or more GPS coordinates or similar references to a coordinate system. The coordinates may reference a point or plurality of points, such as may define a route. In an embodiment, a location may refer to a landmark, business, residence, etc. A plurality of points may refer to a route, including one or more of a starting location, roads traveled, and/or an ending location. Locations may also include a mobile object's 140 place of manufacture, where maintenance events occur, where notable events such as collisions, hail damage, etc. may have occurred. Locations may also refer to places where a subject may have experienced a memorable or other significant event. Alternatively, the coordinates may have a vertical dimension representing altitude or elevation. Locations may further refer to other features, natural, or artificial, to define their location such as a lake, river, ocean, road, trail, etc. Associated data may not match exactly. For example, some references may use a road or address, such as 90 Breezy Acres, while another reference may use a coordinate reference. Similarly, businesses may be described both by the name of the business, the name of an owner, and/or the address of the location. Similarly, businesses may move, while locations may retain the business name. For example, if a “Grand Union” grocery store used to be at 30 Main Street but went out of business and was replaced by a “Walgreens,” then 30 Main Street, “Walgreens”, or “the old Grand Union” may all be equivalent references.

A subject database 110 stores data related to subjects, which may be people, animals, objects, etc. In an ideal embodiment, a subject database 110 stores data primarily related to people. The subject data may relate to specific people, or groups of people. Groups of people may be referenced directly or may comprise an aggregation of data about people belonging to or who can be associated with the group. For example, a group of people may refer to potential buyers of a mobile object 140. Alternatively, a group may refer to people who own or have owned a particular mobile object 140, such as a Ford F-150.

The server system 112 initiates a data collection module 114 and receives data elements collected and identified by the data collection module 114. The server system 112 selects a first data element and initiates a subject module 116, sending the selected data element and receiving subject data comprising data associated with the selected data element. The server system 112 initiates the event module 118, sending the selected data clement and receiving event data comprising data associated with the selected data element. The server system 112 initiates the location module 120, sending the selected data element and receiving location data comprising data associated with the selected data element. The server system 112 may then optionally initiate one or more optional modules, sending the selected data element and receiving data related to the optional module comprising data associated with the selected data element. If there are more data elements, another data element is selected and the subject module 116, event module 118, location module 120, and optionally one or more optional modules, may be initiated for each selected data element. If there are no additional data elements, the server system 112 initiates the perspective module 122 and receives data related to a perspective received from a user which has been aggregated. If the aggregated data is to be transferred to another party, initiate the transfer module 124, and receive a transfer status. If the story is not complete, then initiate the perspective module 122 to receive additional perspective parameters to update the story. If the story is complete, then ending the story aggregation.

The data collection module 114 is initiated by the server system 112 and receives data from a data source which may be any of a user via a user device 134, a camera 136, one or more sensors 138, a second system 126, third party network 128, third party database 130, IoT data source 132, etc. The data collection module 114 identifies one or more data elements from the received data and queries a source database 104 for a source reliability score, or for data to facilitate determining a source reliability score. The received data, identified data elements, and source reliability score(s) are then saved to each the event database 106, the location database 108, and the subject database 110 depending on the relevance of the identified data elements to each of the databases. In some embodiments, the identified data elements may additionally be saved to one or more optional databases.

The subject module 116 is initiated by the server system 112 from which it receives a data clement and queries a subject database 110. A subject similar to the received data element is selected and the received data element and the selected subject data are compared to determine whether they match. The data element and subject data match if it can be determined that the data describe the same subject, or person. If the data matches, the data are saved to the subject database 110 as matching subjects, that is that they describe the same subject or can be associated with each other, such as may be the case if the data element and the selected subject comprise different levels of specificity, such as describing a person who is the owner of a pickup truck versus a specific person who owns a specific mobile object 140, such as a Ford F-150. The subject module 116 checks whether there are more subjects similar to the received subject data. If there are more similar subjects, another subject is selected, and the comparison process is repeated until there are no remaining similar subjects. If there are no similar subjects which match or can be associated with the received data element, the received data element may be saved to a subject database 110 as a new subject. The received data may be saved as a new subject even if it matches or is associated with one or more subjects if the received data clement is more specific than the matched or associated subject data. For example, if the matched or associated subject data relates to a maintenance technician, the received data element may be saved as a new subject if it comprises descriptions of the specific maintenance technician, John Smith. The saved subject data may additionally comprise a source reliability or trust score. The matching and/or associated subject data is then sent to the server system 112.

The event module 118 is initiated by the server system 112 from which it receives event data and queries an event database 106. An event similar to the received event data is selected and the received event data and the selected event data are compared to determine whether they match. The received event data and event data match if it can be determined that the data describes the same event. If the data matches, the data are saved to the event database 106 as matching events, that is that they described the same event or can be associated with each other, such as may be the case if the data element and the selected event comprise different levels of specificity, such as describing the purchase of a pickup truck versus the purchase of a 2013 Ford F-150 by James Barker. The event module 118 checks whether there are more events similar to the received event data. If there are more similar events, another event is selected, and the comparison process is repeated until there are no remaining similar events. If there are no similar events which match or can be associated with the received data element, the received data element may be saved to an event database 106 as a new event. The received data element may be saved as a new event even if it matches or is associated with one or more events if the received data element is more specific than the matched or associated event data. For example, if the matched or associated event data relates to the purchase of a pickup truck, the received event data may be saved as a new event if it further comprises the purchase of a 2013 Ford F-150 by James Barker. The saved event data may additionally comprise a source reliability or trust score. The matching and/or associated event data is then sent to the server system 112.

The location module 120 is initiated by the server system 112 from which it receives location data and queries a location database 108. A location similar to the received location data is selected and the received location data and the selected location data are compared to determine whether they match. The received location data and selected location data match if it can be determined that the data describe the same location. If the data matches, the data are saved to the location database 108 as matching locations, that is that they described the same location or can be associated with each other, such as describing the same location, region, road, etc. The location module 120 checks whether there are more locations similar to the received location data. If there are more similar locations, another location is selected, and the comparison process is repeated until there are no remaining similar locations. If there are no similar locations which match or can be associated with the received location data, the received location data may be saved to a location database 108 as a new location. The received location data may be saved as a new location even if it matches or is associated with one or more locations if the received location data is more specific than the matched or associated location data. For example, if the matched or associated event data describes a road, such as Broadway, New York, NY, the received data element may be saved as a new location if it comprises a more specific location, such as a specific address, 558 Broadway, New York, NY. The saved location data may additionally comprise a source reliability or trust score. The matching and/or associated location data is then sent to the server system 112.

The perspective module 122 is initiated by the server system 112 and receives one or more perspective parameters describing a desired story to be generated. Each of the event database 106, location database 108, and subject database 110 are queried, in addition to any relevant optional databases and data relevant to the received perspective parameters are selected. Each of the selected data records are arranged chronologically and based upon physical locations. In an embodiment, the aggregated story comprises the experiences of the owner of a 2013 Ford F-150, James Barker. In another embodiment, the aggregate story comprises a history of registration and/or maintenance fees due/or paid related to a 2013 Ford F-150. The aggregated data, which may comprise further ordering, is returned to the server system 112.

A transfer module 124 receives aggregated data from the server system 112 and identifies a transferee perspective representative of a party to who the data will be transferred. Further, a transfer condition is identified, which when satisfied, the data will be transferred, at least in part, to the transferee. If the condition is not satisfied, the transfer will not occur. The data transfer may comprise sharing access and/or ownership and in some embodiments may include the surrender of ownership and/or access to some or all of the data by the previous owner. A data transfer status is returned to the server system 112.

Second system 126 can be a distributed network of computational and data storage resources which may be available via the internet or by a local network. Second system 126 accessible via the internet is can be referred to as a public cloud whereas second system 126 on a local network can be referred to as a private cloud. Second system 126 may further be protected by encrypting data and requiring user authentication prior to accessing its resources.

A third party network 128 is comprised of one or more network resources owned by another party. For example, a third party network 128 may refer to a service provider, such as those providing social networks such as Facebook or Twitter. Alternatively, a third party network 128 may refer to a news website or publication, a weather station, bank, auto loan services, insurance company, department of motor mobile objects, etc.

A third party database 130 stores data owned by another party. For example, a third party database 130 may store data on a third party network, or may alternative comprise archival data, historical accounts, survey results customer feedback, social media posts, etc. In one embodiment, a third party database 130 may include for example, a department of motor mobile objects database of registration status and/or fees due and/or paid. In another embodiment, a third party database 130 may comprise a series of social media posts and comments related to a mobile object or type of mobile object, such as Ford mobile objects, luxury mobile objects, off-road mobile objects, etc., such as on Facebook or Twitter. Third party data may further comprise or be utilized to identify sentiment related to a mobile object or type of mobile object.

An IoT (Internet of Things) IoT data source 132 is an internet connected device which may comprise one or more sensors or other sources of data. IoT data sources 132 may comprise appliances, machines, and other devices, often operating independently, which may access data via the internet, second system 126, or which may provide data to one or more internet connected devices or second system 126.

A user device 134 is a computing device which may comprise any of a mobile phone, tablet, personal computer, smart glasses, audio, or video recorder, etc. In some embodiments, a user device 134 may include or be comprised of a virtual assistant. In other embodiments, a user device 134 may comprise one or more cameras 136 and/or sensors 138. A user device 134 may comprise a user interface for receiving data inputs from a user.

A camera 136 is an imaging device or sensor 138 which collects an array of light measurements which can be used to create an image. One or more measurements within the array of measurements can represent a pixel. In some examples, the camera 136 includes an image sensor having an array of photodetectors corresponding to different pixels in an image, and/or to different color channels (e.g., red, green, blue). In some embodiments, multiple measurements are combined (e.g., averaged, converted from one color space to another) together to determine the value(s) to represent one pixel. In other embodiments, one measurement may be used to populate multiple pixels. The number of pixels depends on the resolution of the sensor 138, comprising the dimensions of the array of measurements, or the resolution of the resulting image. The resolution of the camera 136 sensor 138 does not need to be the same as the resolution of the resulting image. A camera 136 may be a component in a user device 134 such as a mobile phone, or alternatively may be a standalone device. In some embodiments, a camera 136 may be analog, where an image is imprinted on a film or other medium instead of measured as an array of light values. In some examples, image data captured by the camera 136 can include still images, videos, video frames (image frames) of a video, or a combination thereof.

A sensor 138 is a measurement device for quantifying at least one physical characteristic such as temperature, acceleration, orientation, sound level, light intensity, force, capacitance, etc. A sensor 138 may be integrated into a user device 134, such as an accelerometer in a mobile phone, or may be a standalone device. A sensor 138 may also be found in an IoT data source 132 or a third party network 128. Sensors 138 may further include occupancy sensors which may be found in a seat or utilize infrared or optical sensors to identify the presence and location of people in a mobile object 140, air bag sensors detecting whether an airbag has deployed, is in standby, or has encountered an error, etc. Sensors 138 may additionally include speed, engine temperature and RPM, fuel usage, tire pressure, cameras, and any other device or indicator in or on a mobile object 140 for measuring or indicating a status, characteristic of the mobile object 140, or other operational parameters. Sensors 138 may further comprise or communicate with a monitoring, diagnostic, and/or control system such as an on-board diagnostic system (ODS) or tire pressure monitoring system (TPMS). Sensors may include indicators such as turn signals, odometer, engine status, etc.

In some examples, the sensors 138 can include cameras, image sensors, range sensors, distance sensors, depths sensors, microphones, ambient light sensors, gyroscopes, gyrometers, accelerometers, inertial measurement unit(s), or a combination thereof. Examples of range sensors, distance sensors, and/or depths sensors can include, for instance, radio detection and ranging (RADAR) sensor(s), light detection and ranging (LiDAR) sensor(s), electromagnetic detection and ranging (EmDAR) sensor(s), sound detection and ranging (SODAR) sensor(s), sound navigation and ranging (SONAR) sensor(s), time of flight (ToF) sensor(s), structured light sensor(s), stereoscopic camera(s), laser rangefinder(s), or a combination thereof.

A mobile object 140 is an object that is capable of moving and/or being moved. In some instances, the mobile object 140 may be referred to as a non-fixed object. In some embodiments, the mobile object 140 may be a vehicle. For example, mobile object 140 may be a machine for transporting people, things, etc. from one location to another. Mobile objects 140 may refer to land-based mobile objects 140 such as automobiles, trucks, buses, tractors, motorcycles, etc. Mobile objects 140 may alternatively refer to water or sea-based mobile objects 140 such as boats, ships, barges, etc. Mobile objects 140 may alternatively refer to aircraft, such as airplanes, gliders, helicopters, etc. Mobile objects 140 may additionally be multimodal mobile objects 140 such as hovercraft, sea planes, etc. In some examples, a mobile object 140 can include an autonomous vehicle and/or an unmanned vehicle. In some examples, a mobile object 140 can include a vehicle that is manned, human-driven, and/or human-operated. In some examples, a mobile object 140 can include a vehicle that is remote-controlled. In some examples, a mobile object 140 can include a vehicle that has certain functions that operate automatically and/or autonomously, such as $$

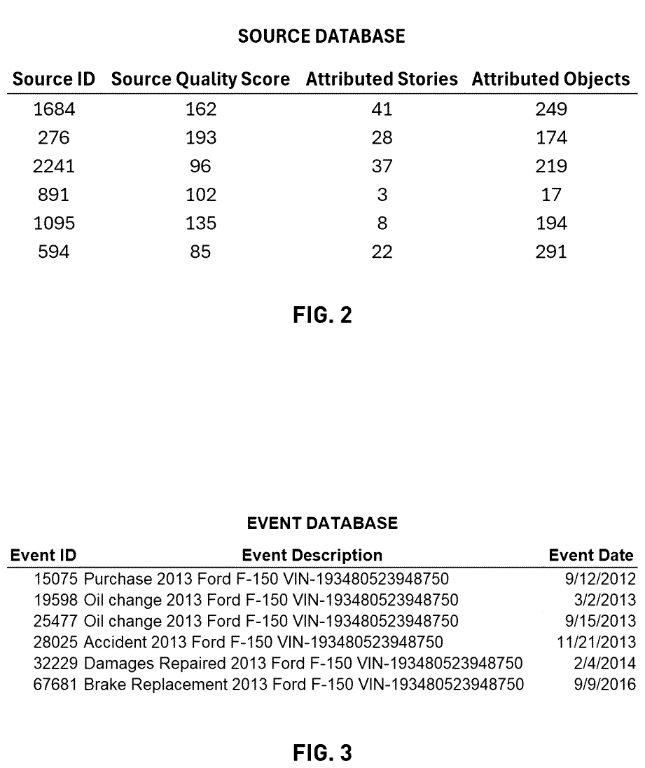

FIG. 2 illustrates an exemplary source database 104. The source database 104 stores data relating to sources of data, and particularly an indication of the trustworthiness or reliability of the source. The reliability of the source may be determined based upon analysis of one or more stories which may be attributed to the source and/or one or more objects which may be attributed to the source. A story is a data record which may be comprised of one or more objects, which are individual data elements. The source database 104 may be populated by a trust verification system. The source database 104 may be used by the server system 112, data collection module 114, subject module 116, event module 118, location module 120, and may be further utilized by one or more optional modules.

FIG. 3 illustrates an exemplary event database 106. The event database 106 stores data related to time-based events such as those which comprise a time data reference. The event data may comprise at least one date and descriptions of one or more events which occurred on that date. The date may additionally comprise a time. The date may instead comprise a year, or a range of years, or alternatively a date range between two specific dates, weeks, months, times, etc. The event database 106 is populated by a data collection module 114 and is updated by an event module 118. The event database 106 may additionally be populated by one or more of a second system 126, third party network 128, third party database 130, IoT data source 132, user device 134, camera 136, or one or more sensors 138. The event database 106 is utilized by the event module 118 and the perspective module 122.

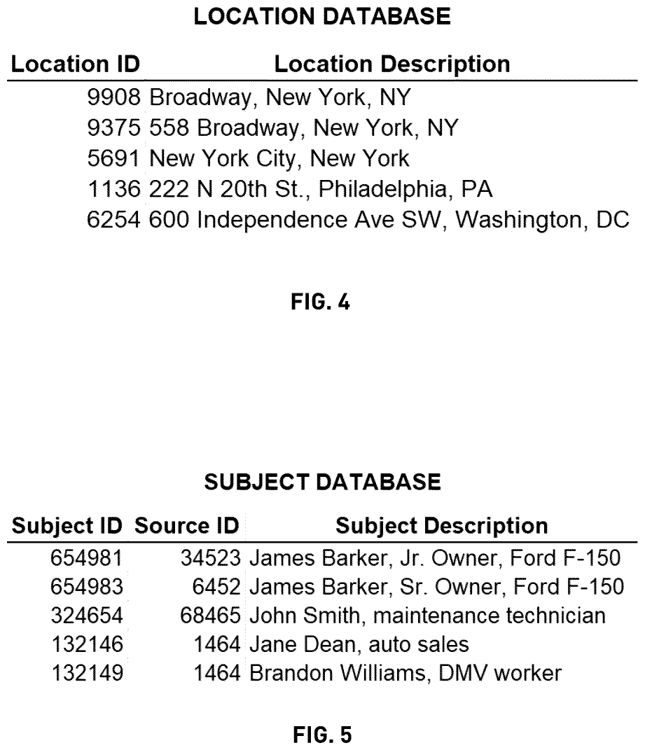

FIG. 4 illustrates an exemplary location database 108. The location database 108 stores data related to location-based data such as those which describe locations. The location data may comprise any of a continent, country, state, city, town, street, address, building, etc. Location related data may also comprise GPS coordinates, regions, including common names, as well as geographic features, such as mountains, valleys, canyons, rivers, streams, lakes, oceans, etc. In an ideal embodiment, the location database 108 stores location references related to events, routes traveled, etc. involving a vehicle. The location database 108 is populated by a data collection module 114 and is updated by a location module 120. The location database 108 may additionally be populated by one or more of a second system 126, third party network 128, third party database 130, IoT data source 132, user device 134, camera 136, or one or more sensors 138. The location database 108 is utilized by the event module 118 and the perspective module 122.

FIG. 5 illustrates an exemplary subject database 110. The subject database 110 stores data related to people, animals, objects, etc., although in ideal embodiments the subject database 110 primarily describes people and characteristics describing them. The subject data may comprise descriptions of a person, groups and affiliations, and roles they may have fulfilled. Examples may comprise job titles they have held, companies they have worked for, musical or theatrical groups with which they performed, military units with which they served and/or fought, etc. Additional data may comprise qualifications, talents, physical descriptions, etc. In an ideal embodiment, the subject database 110 may store data related to a subject's relationship to a vehicle or alternatively a role which is relevant to vehicles such as a vehicle salesperson, mechanic, owner, etc. Subject data may be specific, such that it describes specific individuals, or may be more generalized, such that it describes a group of people. An individual may be a specific mobile object 140 owner, James Barker, and a group may refer to the Barker family. The subject database 110 is populated by a data collection module 114 and is updated by a subject module 116. The subject database 110 may additionally be populated by one or more of a second system 126, third party network 128, third party database 130, IoT data source 132, user device 134, camera 136, or one or more sensors 138. The subject database 110 is utilized by the event module 118 and the perspective module 122.

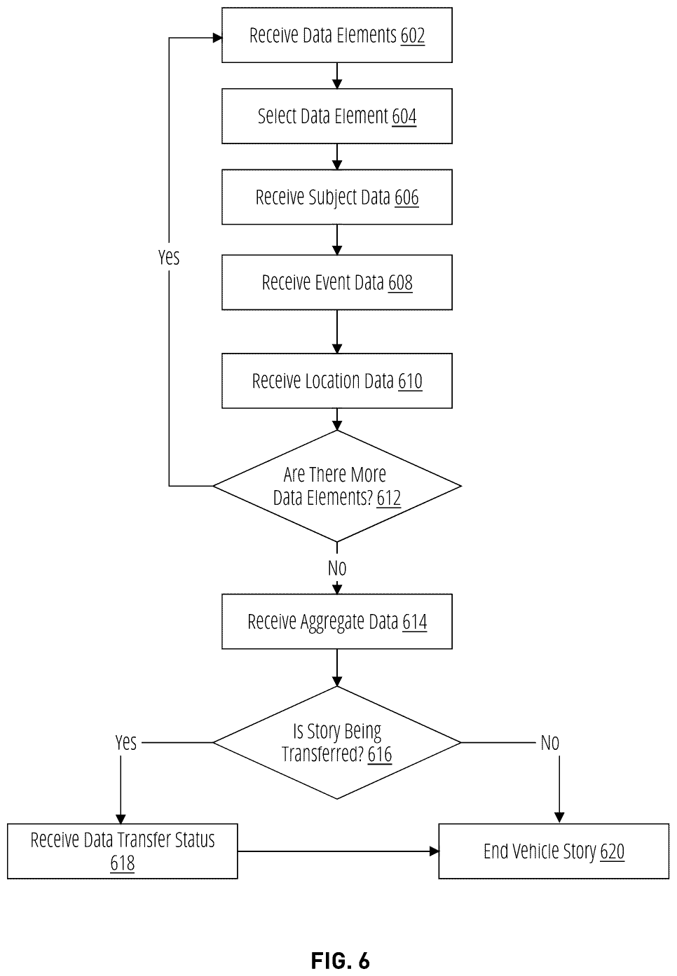

FIG. 6 is a flowchart illustrating an exemplary function of the server system 112. The process begins with initiating the data collection module 114. The data collection module 114 receives data from at least one data source and identifies data elements comprising the received data such as discrete events, locations, people, items, etc. The data collection module 114 queries the source database 104, determines a source reliability score, saves event data to the event database 106, location data to the geography database 108, and subject data to the subject database 110. The saved event data, location data, and subject data may additionally be accompanied by a source reliability score.

Server system 112 receives the identified data elements from the data collection module 114 at operation 602. For example, a data element may be a subject, James Barker, the owner of a 2013 Ford F-150. In another embodiment, the data element may comprise location data such as 558 Broadway, New York, NY. The data elements may further comprise events, such as the sale of a mobile object 140, manufacture and/or maintenance events, accidents, etc.

Server system 112 selects, at operation 604, a data element from the at least one data clement received from the data collection module 114. In an embodiment, selecting the purchase of a 2013 Ford F-150 by James Barker. In an alternate embodiment, selecting the manufacture of a 2013 Ford F-150.

Server system 112 initiates the subject module 116, which receives data comprising at least one subject and querying the subject database 110, selects a subject similar to the received subject data, and determines whether the selected subject data matches the received subject data. If the data matches, server system 112 saves the received data as matching the selected subject to the subject database 110. If the subject data does not match, server system 112 checks whether there are more similar subjects. If there are more similar subjects, server system 112 selects another subject and determines whether the selected subject data matches the received subject data. If the received subject data does not match any data from the subject database 110, then server system 112 saves the received subject data as a new subject to the subject database 110.

Server system 112 receives, at operation 606, the subject data from the subject module 116. The subject data comprises matched subjects and/or newly identified subjects. Subjects may comprise people or things. Matching subjects are associated so as to add new details to an existing subject and/or corroborate existing details. Subject data may additionally be accompanied by a source score which indicates the reliability of the source. The reliability of the source may be retrieved from the source database 104 and/or may utilize a story corroboration system or other method of determining the reliability of the received data.

Server system 112 initiates the event module 118, which receives data comprises at least one event and querying the event database 106, selects an event similar to the received event data., and determines whether the selected event data matches the received event data. If the data matches, server system 112 saves the received data as matching the selected event data to the event database 106. If the event data does not match, server system 112 checks whether there are more similar events. If there are more similar events, then server system 112 selects another event and determines whether the selected event data matches the received event data. If the received event data does not match any data from the event database 106, then server system 112 saves the received event data as a new event to the event database 106.

Server system 112 receives, at operation 608, the event data from the event module 118. The event data comprises matched events and/or newly identified events. Events may comprise discrete or notable actions, or other time-based data. In some embodiments, an event may refer to something which occurred or the state of people, things, etc. at a specific date and/or time. The resolution of time may be one or more years, months, weeks, days, hours, minutes, seconds, etc. Matching events are associated so as to add new details to an existing event and/or corroborate existing details. Event data may additionally be accompanied by a source score which indicates the reliability of the source. The reliability of the source may be retrieved from the source database 104 and/or may utilize a story corroboration system or other method of determining the reliability of the received data.

Server system 112 initiates the location module 120, which receives data comprising at least one location and querying the location database 108, selects a location or location characteristic similar to the received location data, and determines whether the selected location data matches the received location data. If the data matches, server system 112 saves the received data as matching the selected location data to the location database 108. If the location data does not match, server system 112 checks whether there are more similar locations. If there are more similar locations, then server system 112 selects another location and determines whether the selected location data matches the received location data. If the received location data does not match any data from the location database 108, then server system 112 saves the received location data as a new location to the location database 108.

Server system 112 receives, at operation 610, the location data from the location module 120. The location data comprises matched locations and/or newly identified locations. Locations may describe countries, regions, cities, towns, villages, streets, buildings, etc. or may alternatively comprise a set of coordinates such as GPS or map coordinates. The resolution of location may comprise a distance or area of any scale ranging from inches or feet, millimeters, or meters, to hundreds or thousands of miles or kilometers. In some embodiments, locations may be described by natural geographic features such as lakes, rivers, streams, mountains, valleys, canyons, etc. Matching locations are associated so as to add new details to an existing location and/or corroborate existing details. Location data may additionally be accompanied by a source score which indicates the reliability of the source. The reliability of the source may be retrieved from the source database 104 and/or may utilize a story corroboration system or other method of determining the reliability of the received data.

Server system 112 checks, at operation 612, whether there are more data elements. If there are more data elements, then server system 112 returns to operation 604 and selects another data element. For example, there may be another data element comprising the brake replacement of a 2013 Ford F-150, therefore server system 112 returns to operation 606 and selects the data element comprising the brake replacement of a 2013 Ford F-150. In another example, there are no more data elements.

Server system 112 initiates the perspective module 122, which receives a perspective from the user. The perspective may comprise any one or more of a subject, event, location, etc. For example, a perspective may comprise the owner of a 2013 Ford F-150. The perspective module 122 queries the event database 106, the location database 108, and the subject database 110 for data relating to the provided perspective. The related data is then used to create a timeline of events, a map of events, and may additionally summarize a plurality of perspectives such as from multiple subjects and data sources. In some embodiments, additional modules may be utilized to identify, match, and retrieve more specific types of data.

Server system 112 receives, at operation 614, the aggregate data from the perspective module 122. The aggregate data is assembled to form a story such as via a chronological account of events. The aggregate data may comprise a plurality of accounts, which may be summarized from a plurality of subject, event, or location data. In some embodiments, the aggregate data may comprise generalizations or inferences from the available data. In other embodiments, the aggregate data may be more specific, such as the manufacture and maintenance history for a 2013 Ford F-150 according to maintenance records, registration receipts, invoices, etc.

Server system 112 determines, at operation 616, whether the story is being transferred. The story may be transferred if an event occurs which requires the transfer of information, such as the sale of a mobile object 140. Alternatively, a story may be transferred, or shared, with riders, insurers, or for another purpose, such as to facilitate the maintenance of a mobile object 140 by a maintenance technician. In such examples, the story, if applicable, may be transferred in part, or full, and similarly, access to the story may be removed or maintained for the original owner of the information.

Server system 112 initiates the transfer module 124, which sends the aggregate data and/or story to the transfer module 124 and identifying at least one transferee perspective. If the transferee perspective and the aggregate data and/or story perspectives are relevant, identify a transfer condition and/or event upon which the data should be transferred. The data is transferred when the transfer condition has been satisfied and may comprise sharing of data, or a complete or partial transfer of relevant data. In some embodiments, the aggregate data and/or story may be altered to be relevant to the transferee's perspective which may include removing personal information related to the original owner.

Server system 112 receives, at operation 618, a data transfer status from the transfer module 124. The data transfer status may indicate that the transfer of data has occurred. In other embodiments, the data transfer status may indicate an error or other condition where the data transfer did not occur. Server system 112 ends, at operation 620, the vehicle story aggregation and transfer if the story is complete.

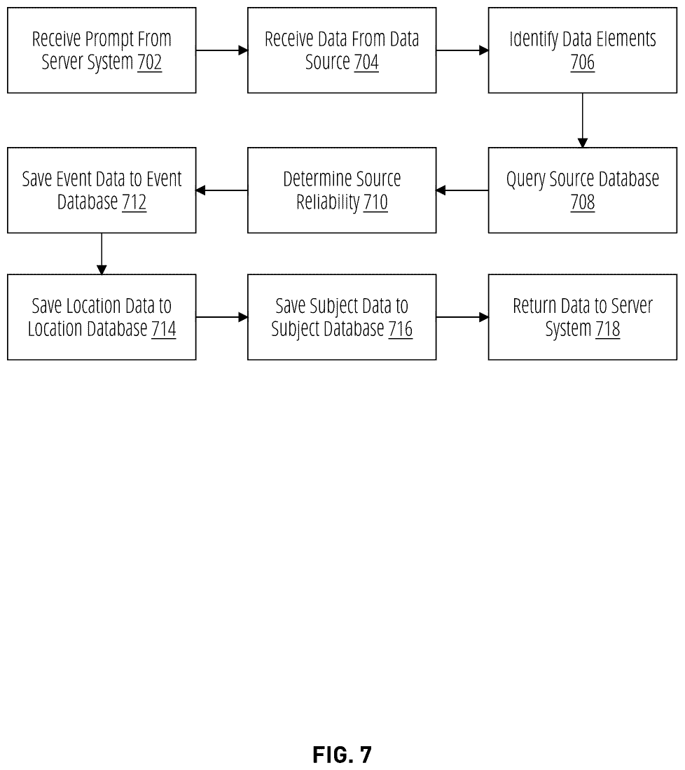

FIG. 7 is a flowchart illustrating an exemplary function of the data collection module 114. The process begins with receiving, at operation 702, a prompt from the server system 112 to begin collecting data from at least one user and/or data source.

Operation 704 includes receiving data from at least one data source. In an embodiment, the data source may comprise a user using a user device 134. The user may manually input data via a physical or virtual keyboard interface or may alternatively dictate the input data verbally or upload one or more images taken by one or more cameras 136. In one embodiment, the data source might include a resident of a property, who shares memories of the house through a user device 134. The resident might relay stories about a famous local artist who once stayed at the property or the joy of homeschooling children in a specially designed room. The data source may alternatively comprise any of second system 126, third party network 128, third party database 130, IoT data source 132, camera 136, sensors 138, or a user device 134. In some embodiments, the data source may include, for example a third party network 128 such as a Facebook page for a particular vehicle, a car club website, or fan club of a particular manufacturer may include images of automobiles racing, performing daring maneuvers, or taken in interesting places or with interesting people. Some of the data may come from comments left by fans, owners, past owners, or perspective owners. From these sources, it is possible, through the social identity of objects to ascertain the vehicles online popularity, and some relationships in time, space and to other people, places, things or events. Further, the data source may comprise one or more sensors and/or sources of data on, in, or related to a vehicle, such as tire pressure monitoring, speed, GPS location and direction of travel, time, occupancy sensors, audio system, microphones within the cabin of the vehicle, etc. The data sources may be integrated with the vehicle, such as tire pressure monitoring systems, occupancy sensors, audio system, etc., or may be independent of the vehicle, such as an aftermarket dash camera, GPS, sound system, etc. The data collection may be passive, such as passively recording from a camera 136 or one or more sensors 138 which may include a microphone, GPS, tire pressure monitoring system, etc. The data collection may also comprise receiving data from remote sources, such as second system 126, third party network 128, third party database 130, or an IoT data source 132. Likewise, a camera 136 may be one or more security cameras observing one or more individuals, locations, events, etc., backup and/or parking assistance camera, dash camera, etc. In some embodiments, the received data may comprise maintenance and/or repair records and/or invoices, mobile object 140 listings, sales, etc. The received data may also comprise data related to events occurring at a specific location or involving a particular mobile object 140 or type of mobile object 140. Examples of types of mobile objects 140 may include vehicles, such as cars, buses, trucks, etc.

Operation 706 includes identifying at least one data element from the received data. A data element may comprise a data characteristic, such as a person, animal, object, location, time, event, etc. Data elements may be identified differently depending upon the format of the data. For example, if the data is provided as text, a transcription, or an audio dialogue, the language may be analyzed, primarily segregating by nouns and verbs, and further evaluating whether each noun or verb references a discrete element. Nouns may indicate a person, animal, object, location, time, events, etc. whereas verbs may additionally refer to events. Alternatively, the data may be subjected to an algorithm or utilize machine learning and/or artificial intelligence to use methods such as a convolutional neural network to segregate the content into discrete elements while additionally accounting for context. Image and video may utilize image recognition to identify objects and object characteristics. In some embodiments, objects may be manually defined or refined. A data element may be a subject, such as the owner of a Ford F-150. A data element may be an event, such as an accident, purchase or sale of a mobile object 140, modifications and/or maintenance of a mobile object 140, etc. A data clement may comprise location data such as an address, common name, GPS coordinates, road name, etc. The data elements may additionally include names of passengers in a mobile object 140, such as a vehicle, in addition to a driver.

Operation 708 includes querying the source database 104 for a score indicating the reliability of the data source from which the data was received. The data score may be binary, indicating whether the data source is trustworthy or not. Alternatively, the data score may be a fixed scale, with several degrees of trust or reliability between a minimum and maximum value. In other embodiments, the data score may be numerical with no fixed scale. Likewise, the scale may comprise only positive values, or may additionally allow negative values. In an ideal embodiment, the source reliability score is numerical and not on a fixed scale, and the larger the number, the more reliable the source.

Operation 710 includes determining the reliability of the source by retrieving a source score from the source database 104. In an embodiment, the reliability score for a personal narrative shared by the homeowner might be 432, whereas the reliability score for data extracted from a verified news article about an important event at the property could be higher. In an alternate embodiment, the source does not have a source score and therefore is assigned a default value of 100. In other embodiments, a story verification system is used to verify and corroborate the accuracy of the contributed story to determine the source reliability score. In an embodiment, a personal account of an accident may be less trustworthy than a camera recording of the event. Likewise, a vehicle owner's account of a mechanical issue may be less trustworthy than an invoice from a maintenance technician for work done to replace brakes or repair damages from an accident or other event resulting in damage to a mobile object 140

Operation 712 includes saving identified event data to the event database 106. An example of event data may be the manufacture of a 2013 Ford F-150 concluding on Jul. 22, 2012. In another embodiment, an event may comprise the purchase of a 2013 Ford F-150 on Sep. 12, 2012. The event data may additionally comprise a source reliability score.

Operation 714 includes saving location data to the location database 108. An example of location data may be an address, such as 558 Broadway, New York, NY. In another embodiment, location data may comprise a street name, such as Broadway, New York, NY, or a common name such as the local “Walgreens” or the “Old Grand Union”. The location data may additionally comprise a source reliability score.

Operation 716 includes saving identified subject data to the subject database 110. An example of subject data may be the owner of a 2013 Ford F-150. In another embodiment, a subject may be a passenger in a 2013 Ford F-150. In another embodiment, the subject data may comprise an auto salesperson involved in the sale of a 2013 Ford F-150. In another embodiment, a subject may be a maintenance technician involved in the maintenance of a mobile object 140. The subject data may additionally comprise a source reliability score.

Operation 718 includes returning the data, and source reliability score(s) to the server system 112.

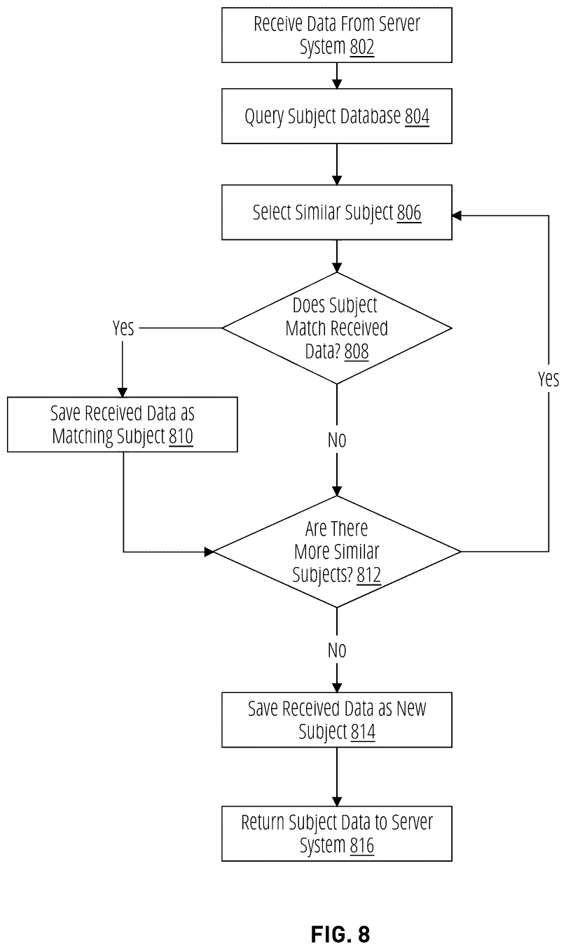

FIG. 8 is a flowchart illustrating an exemplary function of subject module 116. The process begins with receiving, at operation 802, data from the server system 112. The data comprises an identified data element which may include data elements representing subjects such as people, animals, objects, etc. The subject may be specific, such as a specific person, or may be more general, such as referring to all or any person matching a description, such as a vehicle owner, salesperson, buyer, seller, driver, passenger, maintenance technician, etc.

Operation 804 includes querying the subject database 110 for subject data which is similar to the received subject data. For example, if the received subject data comprises a description of the owner of a 2017 Ford F-150, James Barker, then query the subject database 110 for data related to owners of Ford F-150 pickup trucks. If the received subject data related to a dog, then query the subject database 110 for data related to dogs.

Operation 806 includes selecting a subject from the subject database 110 similar to the received subject data. In an embodiment, the received subject data comprising the description of owners of Ford F-150 pickup trucks, therefore selecting a subject from the subject database 110 describing n owner of a Ford F-150 pickup truck.

Operation 808 includes determining whether the selected subject from the subject database 110 matches the description in the received subject data sufficient to confirm that both descriptions describe the same subject. For example, matching a specific vehicle owner may require that the name, date of birth, date of ownership, and other identifiable information is the same sufficient to positively identify and confirm a match. If the subjects do not match, then check if there are more similar subjects. In an embodiment, the received data describes a vehicle owner named James Barker born in 1964, whereas the selected subject data describes a vehicle owner named Joseph Barker born in 1935, therefore the subjects are different despite having the same name. Further, a first vehicle owner named James Barker may be born in 1964, whereas a second vehicle owner, also named Joseph Barker, is born in 1926. As the dates of birth are different, they are not the same person, even if they own the same mobile object 140 or type of mobile object 140. Similarly, a distinction may be made between Joseph Barker Jr. and Joseph Barker Sr. In some instances, these may refer to different people, such as if Jr. refers to the son of Joseph Barker Sr. In other instances, such as where there are three generations of vehicle owners named Joseph Barker, the second generation may both be referred to as Joseph Barker Jr. and Jospeh Barker Sr. depending on the context. The additional context may comprise time data, references to ages, height, etc. In an alternate embodiment, the selected subject data matches the received data element. The data does not need to be an exact match but should not comprise any unresolved conflicts. For example, if the height is off by an inch, but all other descriptions match, there may be a discrepancy with the height approximation, but it may still be concluded that both descriptions reference the same individual. On the other hand, if the descriptions have a key detail which cannot be resolved, such as the name on a document, then the discrepancy cannot be resolved, unless the description included a statement that the individual legally changed their name or otherwise assumed an alias matching the subject. It should also be noted that a data match may either be exact or may be generalized or more relative. For example, in some embodiments the received subject data may be evaluated for an exact match to a specific person, whereas in other embodiments, it may be more general, such as matching the description of a vehicle owner, maintenance technician, salesperson, etc. In such embodiments, details such as a name may only be relevant if it is compared against a database comprising vehicle ownership or registration documents, etc.

Operation 810 includes saving the received data as matching the selected data to the subject database 110. A source reliability score may additionally be determined and saved to the subject database 110 with the matched data.

Operation 812 includes checking whether there are more subjects from the subject database 110 which are similar to the received subject data. If there are more similar subjects, then return to operation 806 and select an additional subject. In an embodiment, additional subject data describes another vehicle owner who owned a 2013 Ford F-150, therefore returning to operation 806, and selecting the subject describing another vehicle owner who owned a 2013 Ford F-150. In an alternate embodiment, there are no additional subjects similar to the received subject data.

Operation 814 includes saving the received data to the subject database 110 as a new subject if the received subject data does not match any existing data records from the subject database 110. A source reliability score may additionally be determined and saved to the subject database 110 with the new subject data. In some embodiments, the source reliability score may be a default value.

Operation 816 includes returning the subject data to the server system 112. The subject data may comprise the received subject data and/or the subject data from the subject database 110 to which it matched.

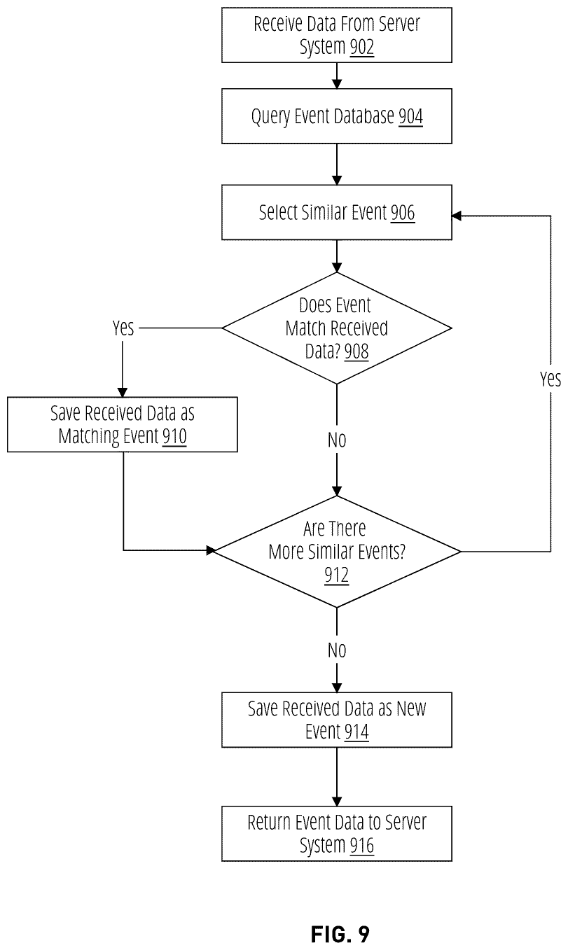

FIG. 9 is a flowchart illustrating an exemplary function of event module 118. The process begins with receiving, at operation 902, data from the server system 112. The data comprising an identified event data which may include data representing events or time related data such as a date and/or time of an event involving a mobile object 140. Examples of events include purchase, manufacture, maintenance, use, accidents, and other events involving a mobile object 140. The data may also comprise a storm or other weather event, trips with passengers, etc. The event data may be comprised of any of a range of resolutions, such as a year, month, week, day, hour, minute, second, etc. and may further comprise a time period which may be segmented accordingly. For example, event data may comprise a date range during which a 2013 Ford Explorer was manufactured, or otherwise repaired from damage sustained during an accident, which may have spanned a period of three months. Alternatively, event data may comprise an oil change occurring over the span of 30 minutes.

Operation 904 includes querying the event database 106 for event data which is similar to the received event data. For example, if one of the received event data elements comprises a description of the purchase of a 2013 Ford F-150, then query the event database 106 for data related to mobile object 140 purchases. If the received event data elements relate to a weather event, such as hail which may have damaged mobile objects 140, then query the event database 106 for data related to hail events resulting in damage to mobile objects 140.

Operation 906 includes selecting an event from the event database 106 similar to the received data element. In an embodiment, the received data clement comprising the description of a purchase of a 2013 Ford F-150, therefore selecting an event from the event database 106 describing a mobile object 140 purchase.

Operation 908 includes determining whether the selected event from the event database 106 matches the description in the received data element sufficient to confirm that both descriptions describe the same event. For example, matching the purchase of a 2013 Ford F-150 may comprise comparing details from an account of the purchase to documents, such as an auto loan application, mobile object 140 registration, insurance contract, etc. If the events do not match, then check if there are more similar events. In an embodiment, the received data describes the purchase of a 2013 Ford F-150 by James Barker by an auto salesperson and the selected event is a purchase of a 2013 Ford F-150 as described by an auto loan application. The data is determined to be a match as the data on the auto loan application includes James Barker's name and personal identifiable information. Further corroboration is comprised by the matching timeframe, with the purchase being reported the same day as the date on the auto loan application. In an alternate embodiment, the selected event is the registration of a 2013 Ford F-150 to James Barker registered with the department of motor mobile objects 140.

Operation 910 includes saving the received data as matching the selected data to the event database 106. A source reliability score may additionally be determined and saved to the event database 106 with the matched data.

Operation 912 includes checking whether there are more events from the event database 106 which are similar to the received data clement. If there are more similar events, then return to operation 906 and select an additional event. In an embodiment, an additional event describes the purchase of a 2014 Chevy Silverado. In an alternate embodiment, there are no additional events similar to the received event data.

Operation 914 includes saving the received data to the event database 106 as a new event if the received data element does not match any existing data records from the event database 106. A source reliability score may additionally be determined and saved to the event database 106 with the new event data. In some embodiments, the source reliability score may be a default value.

Operation 916 includes returning the event data to the server system 112. The event data may comprise the received event data and/or the event data from the event subject database 110 to which it matched.

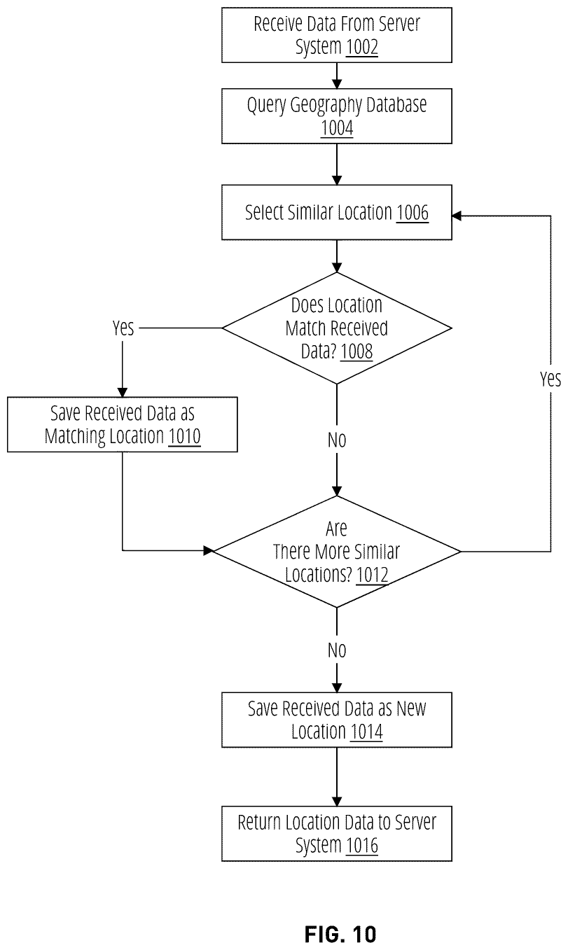

FIG. 10 is a flowchart illustrating an exemplary function of location module 120. The process begins with receiving, at operation 1002, data from the server system 112. The data comprises an identified location data which may include data representing locations such as countries, states, provinces, cities, towns, streets, buildings, GPS coordinates, etc. The location may alternatively refer to natural features such as a mountain, river, ocean, lake, etc. The location may be referred to by a plurality of names by different people, such as describing current and/or former owner's and/or businesses. In an ideal embodiment, the received location data comprising a road name, address, or other form of data defining a location such as GPS coordinates.

Operation 1004 includes querying the location database 108 for location data which is similar to the received location data. For example, selecting location data from the location database 108 related to a mobile object 140, such as a location a mobile object 140 was manufactured, purchased, had maintenance and/or repairs performed, visited, involved in an accident, etc. In some embodiments, the location may be related to a personal experience by a subject, such as the owner, driver, and/or passenger of a mobile object 140 where the mobile object 140 was present.

Operation 1006 includes selecting a location from the location database 108 similar to the received location data. In an embodiment, the received location data comprising the address of an auto dealership. In another embodiment, the received location data comprising the address of a mechanic's garage. In a further embodiment, a location may be a road.

Operation 1008 includes determining whether the selected location from the location database 108 matches the description in the received location data sufficient to confirm that both descriptions describe the same location. For example, matching an address of 558 Broadway, New York, NY to GPS coordinates which are located within the boundaries of 558 Broadway, New York, NY. Alternatively, matching 558 Broadway, New York, NY to Broadway, New York, NY. If the location descriptions do not match, then check if there are more similar locations.

Operation 1010 includes saving that the received location data matches the selected data to the location database 108. A source reliability score may additionally be determined and saved to the location database 108 with the matched data.

Operation 1012 includes checking whether there are more locations from the location database 108 which are similar to the received location data. If there are more similar locations, then return to operation 1006 and select an additional location. In an embodiment, an additional element describes a location at 600 Independence Ave SW, Washington, DC, therefore returning to operation 1006 and selecting the location 600 Independence Ave SW, Washington, DC. In an alternate embodiment, there are no additional locations similar to the received location data.

Operation 1014 includes saving the received data to the location database 108 as a new location if the received location data does not match any existing data records from the location database 108. A source reliability score may additionally be determined and saved to the location database 108 with the new location data. In some embodiments, the source reliability score may be a default value.

Operation 1016 includes returning the location data to the server system 112. The location data may comprise the received location data and/or the location data from the location database 108 to which it matched.

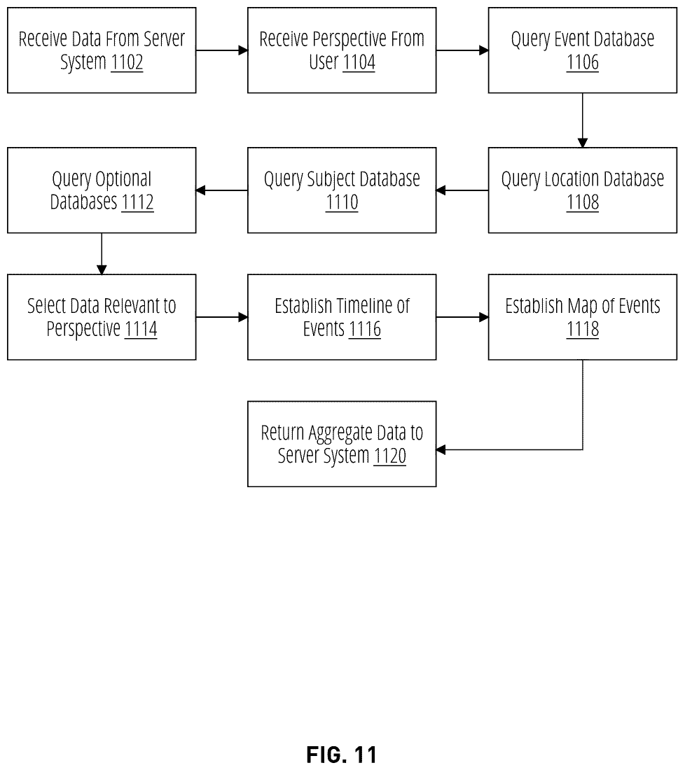

FIG. 11 is a flowchart illustrating an exemplary function of perspective module 122. The process begins with receiving, at operation 1102, data from the server system 112. data comprises any of subject data, event, location, or subject data. The data can comprise data relating to a mobile object 140.

Operation 1104 includes receiving a perspective from a user. A perspective may comprise query parameters describing a story related to a mobile object 140. For example, the perspective may relate to a person and/or a location and/or an event. The perspective may further relate to a specific time period, a group of people, a location, a mobile object 140, type of mobile object 140, etc. or any combination thereof. The perspective may relate to a person, a group of people, or a classification of people. For example, the perspective may relate to an owner of a specific mobile object 140, such as James Barker who owns a 2013 Ford F-150. Alternatively, the perspective may relate to a maintenance technician who performed maintenance on vehicles and may further relate to maintenance technicians who performed maintenance on a specific mobile object 140, such as a 2013 Ford F-150. Alternatively, the perspective may relate to passengers in a mobile object 140. The time detail may be general, encompassing a specific date, a longer period of time, such as a month or year, or may relate to a specific event, such as a manufacture, sale, or other event such as an accident, maintenance or repair event, etc. Instead of relating to a specific mobile object 140, a perspective may describe a class of mobile object 140, such as pickup trucks, passenger mobile objects 140, aircraft, boats, etc. Likewise, the mobile object 140 being grouped may relate to a geographic region, mobile object 140 manufacturer, associated brand, model year, model, etc. The perspective may further comprise a comparison, such as comparing a specific mobile object 140 to other similar mobile objects 140, such as comparing characteristics of a 2013 Ford F-150 to other pickup trucks within a ten-mile radius of where the specific 2013 Ford F-150 is available for sale. Brand may serve a particular importance for a vehicle, as the perspective of a specific vehicle may be altered based on its overall brand image. For example, a Ford F150 may be, in some embodiments, considered higher on some dimensions if it has mud splashed on the tires or body, since the brand image of the vehicle is hard working, rugged, adventure type vehicle, etc. Compared to mud splashed on a Mercedes Benz, which may have a reduced value on some dimensions, as the brand may be considered more refined, clean, carefully maintained, etc.

Operation 1106 includes querying the event database 106 for time-based data related to the perspective received from the user. For example, retrieving data relating to the purchase of a 2013 Ford F-150 by James Barker. The data may comprise the start and end time of an event, such as the manufacture of a 2013 Ford F-150.

Operation 1108 includes querying the location database 108 for location-based data related to the perspective received from the user. For example, retrieving data related to the 558 Broadway, New York, NY, a location visited by a 2013 Ford F-150. Alternatively, the data may comprise the location of an auto dealership which sold the 2013 Ford F-150 or an auto garage where a maintenance technician performed maintenance on the 2013 Ford F-150.

Operation 1110 includes querying the subject database 110 for subject-based data related to the perspective received from the user. For example, retrieving data related to the owner of a 2013 Ford F-150, James Barker. Alternatively, retrieving data related to a maintenance technician who replaced the brakes on a 2013 Ford F-150. In other embodiments, the retrieved data may relate to an auto salesperson, driver, passenger, maintenance technician, etc. to related to a 2013 Ford F-150. The data may further comprise contextual information about the perspective, for example, environmental factors before, during, and after, an accident, which may include weather conditions, music playing on the radio, volume of the radio, a conversation topic and details being discussed by the vehicle occupants, etc. Likewise, the data may comprise the vehicle's speed, direction of travel, etc.

Operation 1112 includes querying one or more optional databases which may store data relevant to the perspective received from the user, such as details relating to taxes, registration, maintenance, or services rendered to a vehicle owner or other subject affiliated with a mobile object 140. Additional relevant data may comprise analysis of events, subjects, and/or locations by expert sources.

Operation 1114 includes selecting data relevant to the perspective received from the user. The data selection may comprise the use of an application of search criteria to filter the data. Alternatively, an algorithm may be used to identify the most relevant data and filter out irrelevant or less relevant data. Further, an algorithm may comprise a machine learning model including but not limited to a language model such as a generative pre-trained transformer.

Operation 1116 includes establishing a chronological timeline of relevant events from the data selected in response to the perspective received from a user. The timeline allowing each data reference to be referenced in the order in which the details it describes occurred or are relevant to a story relating to the perspective.

Operation 1118 includes establishing a map of relevant locations from the data selected in response to the perspective received from a user. The map allowing each data reference which can be associated with a location to be referenced relative to other data references to describe a physical space, either by generating a virtual representation of the location(s), compile a collection or composite of relevant images, or to create a description of relevant locations. In an embodiment, the map comprising a route traveled by a 2013 Ford F-150. The map may further comprise areas of interest, such as where events occurred related to one or more subjects and/or perspectives.

Operation 1120 includes returning the aggregate data to the server system 112. The aggregate data includes the components of a story and is organized at least by one or more of time and/or location. In an embodiment, the aggregate data includes a narrative about the owner of a 2013 Ford F-150, James Barker, specifically relating to a trip taken on Nov. 21, 2013, and an accident which occurred during the trip. In another embodiment, the aggregate data may include a history of maintenance events, such as oil changes, repaired damages, brake replacements, etc. which were performed while James Baker owned the 2013 Ford F-150. In another embodiment, the aggregate data may include a record of work performed by a maintenance technician on a 2013 Ford F-150. In another embodiment, the aggregate data may include a history of taxes, fines, registration fees due and/or paid related to a 2013 Ford F-150 and may further include fuel and/or maintenance expenses.

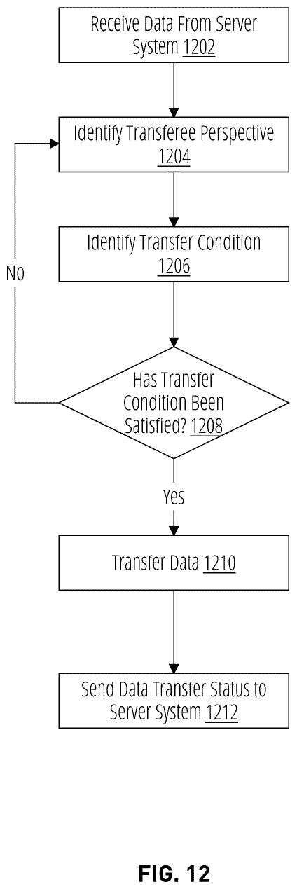

FIG. 12 is a flowchart illustrating an exemplary function of transfer module 124. The process begins with receiving at operation 1202, aggregated data comprising a story from the server system 112. The aggregate story may be from a perspective, such as a vehicle owner, auto salesperson, maintenance technician, etc. and may relate to a mobile object 140. In an embodiment, the story comprising a comprehensive history of mobile object 140 maintenance from the perspective of the current owner of a 2013 Ford F-150.

Operation 1204 includes identifying the perspective of the transferee to determine whether the aggregated data is relevant to the transferee. For example, a transferee may be a potential or contracted buyer of a mobile object 140. In another embodiment, the transferee perspective may be a maintenance technician who is being hired to perform a repair or other maintenance on a mobile object 140. Alternatively, the transferee is a driver, passenger, bystander, etc.

Operation 1206 includes identifying a transfer condition upon which the aggregated data or story may be made available to, shared with, or fully transferred to the transferee. Transfer conditions may include events such as the sale of a mobile object 140. Alternatively, a transfer condition may be signing a contract to employ a maintenance technician to perform repairs to a mobile object 140, or an auto salesperson or dealership to sell or take the mobile object 140 in trade. In other embodiments, a transfer condition may be a passenger of a 2013 Ford F-150, any may specifically comprise an individual involved in an accident. The transfer condition may relate to the type of information in the aggregate data/story or vice versa. In some embodiments, the story may be modified based upon the transfer condition. For example, the story may comprise elements which may be considered private, or otherwise should not be disclosed to the transferee, and therefore may be omitted. Further examples may comprise removing information which may be irrelevant to the transferee and/or the transaction.

Operation 1208 includes determining whether the transfer condition has been satisfied. For example, the transfer condition is satisfied for a transferee purchasing a mobile object 140, if the ownership documents have been signed. Alternatively, the transfer condition may require the digital filing of the sale documents and/or approval of the transaction by a third party. For a passenger of a mobile object 140 during an accident, the transfer condition may be met based on accelerometer data of a user device 134 and location data matched between the user device 134 and the mobile object 140 such as may be determined by GPS coordinates, or other wireless communication and/or geolocation means.

Operation 1210 includes transferring the aggregate data when the transfer condition has been satisfied. The transfer of data may comprise sharing access to the data with the transferee. Alternatively, transferring data may refer to the transfer of custody and access, such as providing access to the data to the transferee, while removing access from the previous owner. In an embodiment, transferring access to the aggregate data comprising the historical maintenance records for a mobile object 140. In other embodiments, the aggregate data may comprise sharing data related to memories, experiences, data collected from a mobile object 140, user device 134, witness accounts, etc. relating to a motor mobile object 140 accident.

Operation 1212 includes sending a data transfer status to the server system 112. The data transfer status may indicate that a data transfer has occurred and may further indicate what data has been transferred. Similarly, the data transfer status may indicate a change or updated access of the involved parties to the data which was transferred. In some embodiments, the data transfer status may indicate an error or other state such that a data transfer did not occur.

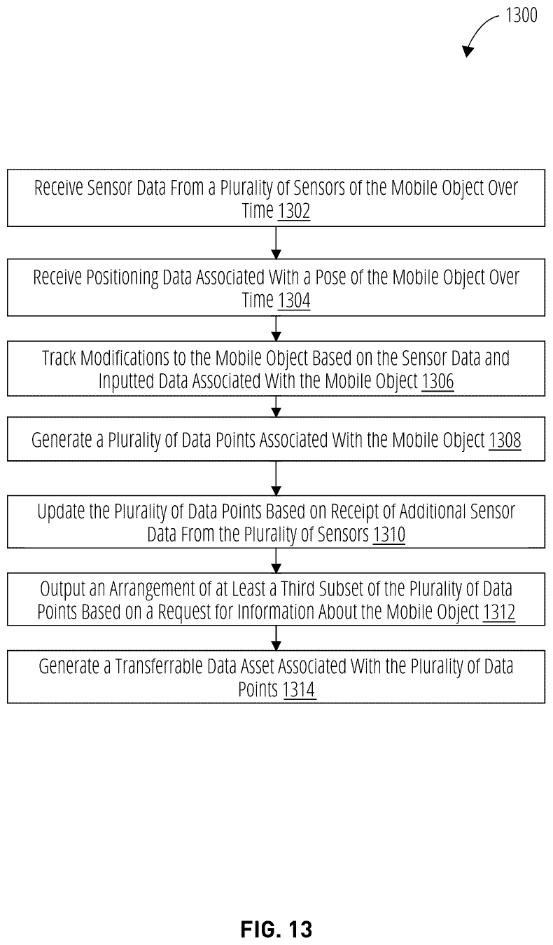

FIG. 13 is a flowchart illustrating an example of a process 1300 for generating a searchable arrangement of data associated with a mobile object. The process is performed by using an objectstory generation system, which may include, for instance, the first system 102, the server system 112, the second system 126, the user device 134, system(s) that perform any of the process(es) illustrated in the flowcharts of FIGS. 6-12, the machine learning system 1400, the ML engine 1420, the ML model(s) 1425, the engine(s) 1445, a computing system and/or computing device with at least one processor performing instructions stored in at least one memory (and/or in a non-transitory computer-readable storage medium), a system, and apparatus, or a combination thereof.

At operation 1302, the object story generation system receives sensor data from a plurality of sensors of the mobile object over time. Examples of the vehicle include the first system 102, the server system 112, the second system 126, the user device 134, system(s) that perform any of the process(es) illustrated in the flowcharts of FIGS. 6-12, the machine learning system 1400, or a combination thereof. Examples of the sensors include the camera 136, the sensor 138, image sensors, range sensors, distance sensors, depths sensors, microphones, ambient light sensors, gyroscopes, gyrometers, accelerometers, inertial measurement unit(s), RADAR sensors, LiDAR sensors, EmDAR sensors, SODAR sensors, SONAR sensors, ToF sensors, structured light sensors, stereoscopic cameras, laser rangefinders, or a combination thereof.

In some examples, the mobile object is a vehicle, such as a ground vehicle, an aerial vehicle, an aquatic vehicle (e.g., underwater or surface of water), or a combination thereof. In some examples, the mobile object is a mobile phone, a wearable device such as a watch, an augmented reality (AR) headset or other device, a virtual reality (VR) headset or other device, a mixed reality (MR) headset or other device, an extended reality (XR) headset or other device, a head-mounted display, a laptop, a gaming console, a tablet, another type of device, or a combination thereof. In some examples, the plurality of sensors include a camera, and the sensor data includes image data captured using the camera.

At operation 1304, the object story generation system receives positioning data associated with a pose of the mobile object over time. In some embodiments, the pose is associated with at least one of a location or an orientation of the mobile object. Location can include coordinates in space, such as X, Y, and Z coordinates; or latitude, longitude, and altitude or elevation. Orientation can include pitch, yaw, and/or roll.

At operation 1306, in some examples, the object story generation system tracks modifications to the mobile object based on the sensor data and inputted data associated with the mobile object. In some examples, at least one modification of the modifications to the mobile object is a modification to the materials used in association with the mobile object, for instance including components and/or other materials used in repairs, performance improvements, and/or other modifications to the mobile object. In some examples, the inputted data include materials used in association with the mobile object and historical information associated with the materials, for instance including components and/or other materials used in the manufacturing of the mobile object.

At operation 1308, the object story generation system generates a plurality of data points associated with the mobile object. In some embodiments, at least a first subset of the plurality of data points track changes within the sensor data over time. In some embodiments, at least a second subset of the plurality of data points track changes to the pose of the mobile object over time. The data points can refer to different aspects of the mobile object, such as different components or materials used in the mobile object (e.g., during manufacturing or modifications), modifications (e.g., repairs, upgrades) to the mobile object, owners of the mobile objects, users (e.g., owners, renters, drivers, operators) of the mobile objects, geographic locations reached and/or visited by the mobile object, geographic areas reached and/or visited by the mobile object, routes traveled (e.g., driven, flown, swam) by the mobile object, distance traveled (e.g., odometer reading) by the mobile object, historical context associated with the mobile object, or a combination thereof.

At operation 1310, the object story generation system updates the plurality of data points based on receipt of additional sensor data from the plurality of sensors. In some embodiments, the plurality of data points is continually updated based on receipt of the additional sensor data. In some embodiments, the plurality of data points is periodically (e.g., at predetermined intervals or dynamic intervals) updated based on receipt of the additional sensor data. In some embodiments, the plurality of data points is updated (e.g., and/or the intervals at which the plurality of data points is periodically updated) in response to an event (e.g., the mobile object enters a geographic area, the mobile object exits a geographic area, the mobile object reaches or exceeds a particular distance threshold, a specific object is detected and/or recognized in the sensor data, or a combination thereof).

At operation 1312, the object story generation system outputs an arrangement of at least a third subset of the plurality of data points based on a request for information about the mobile object. In some embodiments, the request for information is a search or a database query. In some examples, the request is a search query for information about the mobile object, and the arrangement is a search result.

At operation 1314, in some examples, the object story generation system generates a transferrable data asset associated with the plurality of data points. In some examples, association(s) with the transferrable data asset (e.g., ownership of the transferrable data asset) can be transferred using a distributed ledger, such as a blockchain ledger. In some examples, association(s) with the transferrable data asset (e.g., ownership of the transferrable data asset) can be transferred based on rules, such as rules of a smart contract. In some examples, the transferrable data asset can be structured as a token, such as a non-fungible token (NFT).

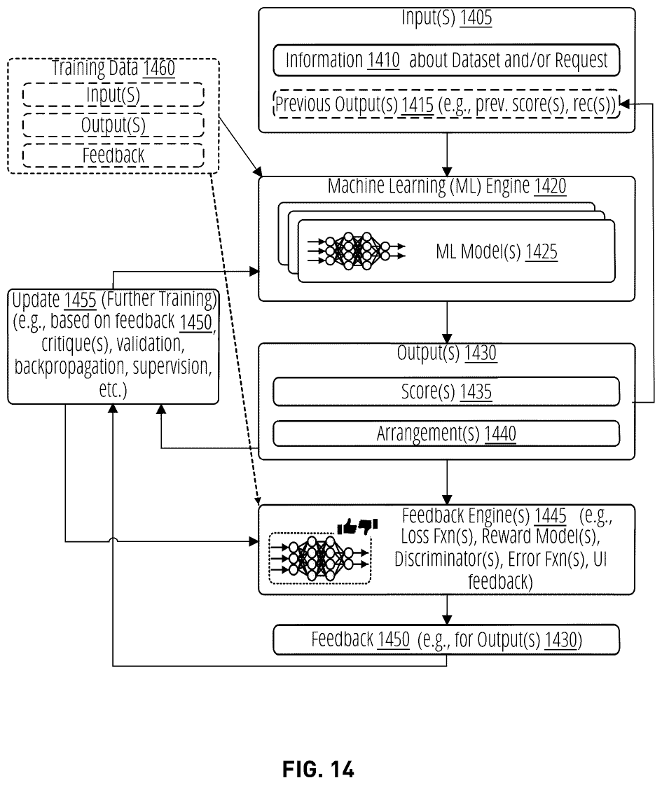

FIG. 14 is a block diagram illustrating an example of a machine learning system 1400 for training, use of, and/or updating of one or more machine learning model(s) 1425 that are used to generate score(s) 1435 and/or arrangement(s) 1440. The machine learning (ML) system 1400 includes an ML engine 1420 that generates, trains, uses, and/or updates one or more ML model(s) 1425. In some examples, object story generation system, first system 102, second system 126, and/or server system 112 include the ML system 1400, the ML engine 1420, the ML model(s) 1425, and/or the feedback engine(s) 1445, or vice versa.

The ML model(s) 1425 can include, for instance, one or more neural network(s) (NN(s)), one or more convolutional NN(s) (CNN(s)), one or more time delay NN(s) (TDNN(s)), one or more deep network(s) (DN(s)), one or more autoencoder(s) (AE(s)), one or more variational autoencoder(s) (VAE(s)), one or more deep belief net(s) (DBN(s)), one or more recurrent NN(s) (RNN(s)), one or more generative adversarial network(s) (GAN(s)), one or more conditional GAN(s) (cGAN(s)), one or more feed-forward network(s), one or more network(s) having fully connected layers, one or more support vector machine(s) (SVM(s)), one or more random forest(s) (RF), one or more computer vision (CV) system(s), one or more autoregressive (AR) model(s), one or more Sequence-to-Sequence (Seq2Seq) model(s), one or more large language model(s) (LLM(s)), one or more deep learning system(s), one or more classifier(s), one or more transformer(s), or a combination thereof. In examples where the ML model(s) 1425 include LLMs, the LLMs can include, for instance, a Generative Pre-Trained Transformer (GPT) (e.g., GPT-2, GPT-3, GPT-3.5, GPT-4, etc.), DaVinci or a variant thereof, an LLM using Massachusetts Institute of Technology (MIT)® langchain, Pathways Language Model (PaLM), Large Language Model Meta® AI (LLaMA), Language Model for Dialogue Applications (LaMDA), Bidirectional Encoder Representations from Transformers (BERT), Falcon (e.g., 40B, 7B, 1B), Orca, Phi-1, StableLM, variant(s) of any of the previously-listed LLMs, or a combination thereof.

Within FIG. 14, a graphic representing the ML model(s) 1425 illustrates a set of circles connected to one another. Each of the circles can represent a node, a neuron, a perceptron, a layer, a portion thereof, or a combination thereof. The circles are arranged in columns. The leftmost column of white circles represent an input layer. The rightmost column of white circles represent an output layer. Two columns of shaded circled between the leftmost column of white circles and the rightmost column of white circles each represent hidden layers. An ML model can include more or fewer hidden layers than the two illustrated, but includes at least one hidden layer. In some examples, the layers and/or nodes represent interconnected filters, and information associated with the filters is shared among the different layers with each layer retaining information as the information is processed. The lines between nodes can represent node-to-node interconnections along which information is shared. The lines between nodes can also represent weights (e.g., numeric weights) between nodes, which can be tuned, updated, added, and/or removed as the ML model(s) 1425 are trained and/or updated. In some cases, certain nodes (e.g., nodes of a hidden layer) can transform the information of each input node by applying activation functions (e.g., filters) to this information, for instance applying convolutional functions, downscaling, upscaling, data transformation, and/or any other suitable functions.

In some examples, the ML model(s) 1425 can include a feed-forward network, in which case there are no feedback connections where outputs of the network are fed back into itself. In some cases, the ML model(s) 1425 can include a recurrent neural network, which can have loops that allow information to be carried across nodes while reading in input. In some cases, the network can include a convolutional neural network, which may not link every node in one layer to every other node in the next layer.

One or more input(s) 1405 can be provided to the ML model(s) 1425. The ML model(s) 1425 can be trained by the ML engine 1420 (e.g., based on training data 1460) to generate one or more output(s) 1430. In some examples, the input(s) 1405 include information 1410. The information 1410 can include, for instance, source data, event data, location data, subject data, etc., or a combination thereof.

The output(s) 1430 that ML model(s) 1425 generate by processing the input(s) 1405 (e.g., the information 1410 and/or the previous output(s) 1415) can include score(s) 1435 and/or arrangement(s) 1440. The score(s) 1435 can include, for instance, “Historocity” scores, trustworthiness scores, reliability scores, source scores, etc. The arrangement(s) 1440 can include, for instance, an estimate of an object's significance, whether the data source is trustworthy, estimated value for the property, etc. In some embodiments, the arrangement is a transferrable data asset including the score(s) 1435 and other data, such as the estimate of the object's significance, determinations to data source trustworthiness, estimated values of the property, historical information related to the property, etc. The ML model(s) 1425 can generate the score(s) 1435 based on the information 1410 and/or other types of input(s) 1405 (e.g., previous output(s) 1415). In some examples, the score(s) 1435 can be used as part of the input(s) 1405 to the ML model(s) 1425 (e.g., as part of previous output(s) 1415) for generating the arrangement(s) 1440, for identifying a further score(s) 1435, and/or for generating other output(s) 1430. In some examples, at least some of the previous output(s) 1415 in the input(s) 1405 represent previously-identified score(s) that are input into the ML model(s) 1425 to identify the score(s) 1435, the arrangement(s) 1440, and/or other output(s) 1430. In some examples, based on receipt of the input(s) 1405, the ML model(s) 1425 can select the output(s) 1430 from a list of possible outputs, for instance by ranking the list of possible outputs by likelihood, probability, and/or confidence based on the input(s) 1405. In some examples, based on receipt of the input(s) 1405, the ML model(s) 1425 can identify the output(s) 1430 at least in part using generative artificial intelligence (AI) content generation techniques, for instance using an LLM to generate custom text and/or graphics identifying the output(s) 1430.

In some examples, the ML system repeats the process illustrated in FIG. 14 multiple times to generate the output(s) 1430 in multiple passes, using some of the output(s) 1430 from earlier passes as some of the input(s) 1405 in later passes (e.g., as some of the previous output(s) 1415). For instance, in a first illustrative example, in a first pass, the ML model(s) 1425 can identify the score(s) 1435 based on input of the information 1410 into the ML model(s) 1425. In a second pass, the ML model(s) 1425 can identify the arrangement(s) 1440 based on input of the information 1410 and the previous output(s) 1415 (that includes the score(s) 1435 from the first pass) into the ML model(s) 1425.

In some examples, the ML system includes one or more feedback engine(s) 1445 that generate and/or provide feedback 1450 about the output(s) 1430. In some examples, the feedback 1450 indicates how well the output(s) 1430 align to corresponding expected output(s), how well the output(s) 1430 serve their intended purpose, or a combination thereof. In some examples, the feedback engine(s) 1445 include loss function(s), reward model(s) (e.g., other ML model(s) that are used to score the output(s) 1430), discriminator(s), error function(s) (e.g., in back-propagation), user interface feedback received via a user interface from a user, or a combination thereof. In some examples, the feedback 1450 can include one or more alignment score(s) that score a level of alignment between the output(s) 1430 and the expected output(s) and/or intended purpose.

The ML engine 1420 of the ML system can update (further train) the ML model(s) 1425 based on the feedback 1450 to perform an update 1455 (e.g., further training) of the ML model(s) 1425 based on the feedback 1450. In some examples, the feedback 1450 includes positive feedback, for instance indicating that the output(s) 1430 closely align with expected output(s) and/or that the output(s) 1430 serve their intended purpose. In some examples, the feedback 1450 includes negative feedback, for instance indicating a mismatch between the output(s) 1430 and the expected output(s), and/or that the output(s) 1430 do not serve their intended purpose. For instance, high amounts of loss and/or error (e.g., exceeding a threshold) can be interpreted as negative feedback, while low amounts of loss and/or error (e.g., less than a threshold) can be interpreted as positive feedback. Similarly, high amounts of alignment (e.g., exceeding a threshold) can be interpreted as positive feedback, while low amounts of alignment (e.g., less than a threshold) can be interpreted as negative feedback.

In response to positive feedback in the feedback 1450, the ML engine 1420 can perform the update 1455 to update the ML model(s) 1425 to strengthen and/or reinforce weights (and/or connections and/or hyperparameters) associated with generation of the output(s) 1430 to encourage the ML engine 1420 to generate similar output(s) 1430 given similar input(s) 1405. In this way, the update 1455 can improve the ML model(s) 1425 itself by improving the accuracy of the ML model(s) 1425 in generating output(s) 1430 that are similarly accurate given similar input(s) 1405. In response to negative feedback in the feedback 1450, the ML engine 1420 can perform the update 1455 to update the ML model(s) 1425 to weaken and/or remove weights (and/or connections and/or hyperparameters) associated with generation of the output(s) 1430 to discourage the ML engine 1420 from generating similar output(s) 1430 given similar input(s) 1405. In this way, the update 1455 can improve the ML model(s) 1425 itself by improving the accuracy of the ML model(s) 1425 in generating output(s) 1430 are more accurate given similar input(s) 1405. In some examples, for instance, the update 1455 can improve the accuracy of the ML model(s) 1425 in generating output(s) 1430 by reducing false positive(s) and/or false negative(s) in the output(s) 1430.

For instance, here, if the score(s) 1435 and/or arrangement(s) 1440 are corroborated, the corroboration can be interpreted as feedback 1450 that is positive (e.g., positive feedback). For instance, here, if the score(s) 1435 and/or arrangement(s) 1440 are inconsistent with other records, the inconsistency can be interpreted as feedback 1450 that is negative (e.g., negative feedback). Either way, the update 1455 can improve the machine learning system 1400 and the overall system by improving the consistency with which the corroboration or verification is successful.

In some examples, the ML engine 1420 can also perform an initial training of the ML model(s) 1425 before the ML model(s) 1425 are used to generate the output(s) 1430 based on the input(s) 1405. During the initial training, the ML engine 1420 can train the ML model(s) 1425 based on training data 1460. In some examples, the training data 1460 includes examples of input(s) (of any input types discussed with respect to the input(s) 1405), output(s) (of any output types discussed with respect to the output(s) 1430), and/or feedback (of any feedback types discussed with respect to the feedback 1450). In some cases, positive feedback in the training data 1460 can be used to perform positive training, to encourage the ML model(s) 1425 to generate output(s) similar to the output(s) in the training data given input of the corresponding input(s) in the training data. In some cases, negative feedback in the training data 1460 can be used to perform negative training, to discourage the ML model(s) 1425 from generate output(s) similar to the output(s) in the training data given input of the corresponding input(s) in the training data. In some examples, the training of the ML model(s) 1425 (e.g., the initial training with the training data 1460, update(s) 1455 based on the feedback 1450, and/or other modification(s)) can include fine-tuning of the ML model(s) 1425, retraining of the ML model(s) 1425, or a combination thereof.

In some examples, the ML model(s) 1425 can include an ensemble of multiple ML models, and the ML engine 1420 can curate and manage the ML model(s) 1425 in the ensemble. The ensemble can include ML model(s) 1425 that are different from one another to produce different respective outputs, which the ML engine 1420 can average (e.g., mean, median, and/or mode) to identify the output(s) 1430. In some examples, the ML engine 1420 can calculate the standard deviation of the respective outputs of the different ML model(s) 1425 in the ensemble to identify a level of confidence in the output(s) 1430. In some examples, the standard deviation can have an inverse relationship with confidence. For instance, if the respective outputs of the different ML model(s) 1425 are very different from one another (and thus have a high standard deviation above a threshold), the confidence that the output(s) 1430 are accurate may be low (e.g., below a threshold). On the other hand, if the respective outputs of the different ML model(s) 1425 are equal or very similar to one another (and thus have a low standard deviation below a threshold), the confidence that the output(s) 1430 are accurate may be high (e.g., above a threshold). In some examples, different ML models(s) 1425 in the ensemble can include different types of models. For instance, in some examples, an ensemble can include a NN and a SVM that are both trained to process the input(s) 1405 to generate at least a subset of the output(s) 1430. In some examples, the ensemble may include different ML model(s) 1425 that are trained to process different inputs of the input(s) 1405 and/or to generate different outputs of the output(s) 1430. For instance, in some examples, a first model (or set of models) can process the input(s) 1405 to generate the score(s) 1435, while a second model (or set of models) can process the input(s) 1405 to generate the arrangement(s) 1440. In some examples, the ML engine 1420 can choose specific ML model(s) 1425 to be included in the ensemble because the chosen ML model(s) 1425 are effective at accurately processing particular types of input(s) 1405, are effective at accurately generating particular types of output(s) 1430, are generally accurate, process input(s) 1405 quickly, generate output(s) 1430 quickly, are computationally efficient, have higher or lower degrees of uncertainty than other models in the ensemble, or a combination thereof.

In some examples, one or more of the ML model(s) 1425 can be initialized with weights, connections, and/or hyperparameters that are selected randomly. This can be referred to as random initialization. These weights, connections, and/or hyperparameters are modified over time through training (e.g., initial training with the training data 1460 and/or update(s) 1455 based on the feedback 1450), but the random initialization can still influence the way the ML model(s) 1425 process data, and thus can still cause different ML model(s) 1425 (with different random initializations) to produce different output(s) 1430. Thus, in some examples, different ML model(s) 1425 in an ensemble can have different random initializations.

As an ML model (of the ML model(s) 1425) is trained (e.g., along the initial training with the training data 1460, update(s) 1455 based on the feedback 1450, and/or other modification(s)), different versions of the ML model at different stages of training can be referred to as checkpoints. In some examples, after each new update to a model (e.g., update 1455) generates a new checkpoint for the model, the ML engine 1420 tests the new checkpoint (e.g., against testing data and/or validation data where the correct output(s) are known) to identify whether the new checkpoint improves over older checkpoints or not, and/or if the new checkpoint introduces new errors (e.g., false positive(s) and/or false negative(s)). This testing can be referred to as checkpoint benchmark scoring. In some examples, in checkpoint benchmark scoring, the ML engine 1420 produces a benchmark score for one or more checkpoint(s) of one or more ML model(s) 1425, and keeps the checkpoint(s) that have the best (e.g., highest or lowest) benchmark scores in the ensemble. In some examples, if a new checkpoint is worse than an older checkpoint, the ML engine 1420 can revert to the older checkpoint. The benchmark score for a can represent a level of accuracy of the checkpoint and/or number of errors (e.g., false positive or false negative) by the checkpoint during the testing (e.g., against the testing data and/or the validation data). In some examples, an ensemble of the ML model(s) 1425 can include multiple checkpoints of the same ML model.

In some examples, the ML model(s) 1425 can be modified, either through the initial training (with the training data 1460), an update 1455 based on the feedback 1450, or another modification to introduce randomness, variability, and/or uncertainty into an ensemble of the ML model(s) 1425. In some examples, such modification(s) to the ML model(s) 1425 can include dropout (e.g., Monte Carlo dropout), in which one or more weights or connections are selected at random and removed. In some examples, dropout can also be performed during inference, for instance to modify the output(s) 1430 generated by the ML model(s) 1425. The term Bayesian Machine Learning (BML) can refer to random dropout, random initialization, and/or other randomization-based modifications to the ML model(s) 1425. In some examples, the modification(s) to the ML model(s) 1425 can include a hyperparameter search and/or adjustment of hyperparameters. The hyperparameter search can involve training and/or updating different ML models 1425 with different values for hyperparameters and evaluating the relative performance of the ML models 1425 (e.g., against (e.g., against testing data and/or validation data where the correct output(s) are known) to identify which of the ML models 1425 performs best. Hyperparameters can include, for instance, temperature (e.g., influencing level creativity and/or randomness), top P (e.g., influencing level creativity and/or randomness), frequency penalty (e.g., to prevent repetitive language between one of the output(s) 1430 and another), presence penalty (e.g., to encourage the ML model(s) 1425 to introduce new data in the output(s) 1430), other parameters or settings, or a combination thereof.

In some examples, the ML engine 1420 can perform retrieval-augmented generation (RAG) using the model(s) 1425. For instance, in some examples, the ML engine 1420 can pre-process the input(s) 1405 by retrieving additional information from one or more data store(s) (e.g., any of the databases and/or other data structures discussed herein) and using the additional information to enhance the input(s) 1405 before the input(s) 1405 are processed by the ML model(s) 1425 to generate the output(s) 1430. For instance, in some examples, the enhanced versions of the input(s) 1405 can include the additional information that the ML engine 1420 retrieved from the from one or more data store(s). In some examples, this RAG process provides the ML model(s) 1425 with more relevant information, allowing the ML model(s) 1425 to generate more accurate and/or personalized output(s) 1430.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A method for generating a searchable arrangement of data associated with a mobile object, the method comprising:
receiving sensor data from a plurality of sensors of the mobile object over time;
receiving positioning data associated with a pose of the mobile object over time;
generating a plurality of data points associated with the mobile object, wherein at least a first subset of the plurality of data points track changes within the sensor data over time, wherein at least a second subset of the plurality of data points track changes to the pose of the mobile object over time;
updating the plurality of data points based on receipt of additional sensor data from the plurality of sensors; and
outputting an arrangement of at least a third subset of the plurality of data points based on a request for information about the mobile object.

2. The method of claim 1, wherein the mobile object is a vehicle.

3. The method of claim 1, wherein the plurality of sensors include a camera, and wherein the sensor data includes image data captured using the camera.

4. The method of claim 1, further comprising:
tracking modifications to the mobile object based on the sensor data and inputted data associated with the mobile object.

5. The method of claim 4, wherein at least one modification of the modifications to the mobile object is a modification to materials used in association with the mobile object.

6. The method of claim 4, wherein the inputted data include materials used in association with the mobile object and historical information associated with the materials.

7. The method of claim 1, wherein the pose is associated with at least one of a location or an orientation of the mobile object.

8. The method of claim 1, further comprising:
generating a transferrable data asset associated with the plurality of data points.

9. The method of claim 1, wherein the plurality of data points is continually updated based on receipt of the additional sensor data.

10. The method of claim 1, wherein the plurality of data points is periodically updated based on receipt of the additional sensor data.

11. The method of claim 1, wherein the plurality of data points is updated in response to an event.

12. The method of claim 1, wherein the request for information is a search or a database query.

13. A system for generating a searchable arrangement of data associated with a mobile object, the system comprising:
memory; and
a processor that executes instructions in memory, wherein execution of the instructions by the processor causes the processor to:
receive sensor data from a plurality of sensors of the mobile object over time;
receive positioning data associated with a pose of the mobile object over time;
generate a plurality of data points associated with the mobile object, wherein at least a first subset of the plurality of data points track changes within the sensor data over time, wherein at least a second subset of the plurality of data points track changes to the pose of the mobile object over time;
update the plurality of data points based on receipt of additional sensor data from the plurality of sensors; and
output an arrangement of at least a third subset of the plurality of data points based on a request for information about the mobile object.

14. The system of claim 13, wherein the mobile object is a vehicle.

15. The system of claim 13, wherein the plurality of sensors include a camera, and wherein the sensor data includes image data captured using the camera.

16. The system of claim 13, wherein execution of the instructions by the processor further:
track modifications to the mobile object based on the sensor data and inputted data associated with the mobile object.

17. The system of claim 16, wherein at least one modification of the modifications to the mobile object is a modification to materials used in association with the mobile object.

18. The system of claim 16, wherein the inputted data include materials used in association with the mobile object and historical information associated with the materials.

19. The system of claim 13, wherein the pose is associated with at least one of a location or an orientation of the mobile object.

20. A non-transitory computer-readable storage medium, having embodied thereon a program executable by a processor to perform a method for generating a searchable arrangement of data associated with a mobile object, the method comprising:
receiving sensor data from a plurality of sensors of the mobile object over time;
receiving positioning data associated with a pose of the mobile object over time;
generating a plurality of data points associated with the mobile object, wherein at least a first subset of the plurality of data points track changes within the sensor data over time, wherein at least a second subset of the plurality of data points track changes to the pose of the mobile object over time;
updating the plurality of data points based on receipt of additional sensor data from the plurality of sensors; and
outputting an arrangement of at least a third subset of the plurality of data points based on a request for information about the mobile object.
